(19) United States
(12) Patent Application Publication
(10) Pub. No.: US 2014/0204000 A1
(43) Pub. Date: Jul. 24, 2014

(54) INFORMATION PROCESSING DEVICE, INFORMATION PROCESSING METHOD, AND PROGRAM

(71) Applicant: Sony Corporation, Minato-ku (JP)

(72) Inventor: Masanori SATO, Tokyo (JP)

(73) Assignee: Sony Corporation, Minato-ku (JP)

(21) Appl. No.: 14/093,902

(22) Filed: Dec. 2, 2013

(30) Foreign Application Priority Data
Jan. 24, 2013 (JP) 2013-010714

(51) Int. Cl. G09G 5/12

(52) U.S. Cl. CPC G09G 5/12
USPC 345/2.3

(57) ABSTRACT

An information processing device includes a communication unit that performs wireless communication using a specific band with another information processing device; and an estimation unit that estimates a position of the another information processing device on the basis of information regarding a beam used at the time of the wireless communication.

### CROSS REFERENCE TO RELATED APPLICATIONS

This application claims the benefit of Japanese Priority Patent Application JP 2013-010714 filed Jan. 24, 2013, the entire contents of which are incorporated herein by reference.

### BACKGROUND

The present disclosure relates to an information processing device, and more particularly, to an information processing device and an information processing method which exchange various pieces of information using wireless communication, and a program causing a computer to execute the method.

Hitherto, there is a wireless communication technique that exchanges various pieces of data using wireless communication. For example, an information exchanging device that exchanges various pieces of information by wireless communication between two devices has been suggested (for example, see Japanese Unexamined Patent Application Publication No. 2008-278388).

### SUMMARY

According to the above-described related art, it is possible to exchange various pieces of information between two devices by wireless communication without a wired circuit connecting the two devices.

In this manner, when various pieces of information are exchanged between two devices using wireless communication, it is convenient if one device can estimate the position of the other device using the wireless communication.

The present disclosure is contrived in view of such situations, it is desirable to estimate the position another information processing device using wireless communication.

According to an embodiment of the present disclosure, there are provided an information processing device including: a communication unit that performs wireless communication using a specific band with another information processing device; and an estimation unit that estimates a position of the another information processing device on the basis of information regarding a beam used at the time of the wireless communication, an information processing method of the information processing device, and a program causing a computer to execute the method. Thus, there is an effect that the position of the another information processing device is estimated on the basis of the information regarding the beam used at the time of the wireless communication.

In the embodiment, the information regarding the beam may include angle information for specifying at least one of a transmission direction of a transmitted beam used at the time of the wireless communication and a reception direction of a received beam used at the time of the wireless communication. The estimation unit may calculate a direction of the another information processing device in a case based on a position of the information processing device on the basis of the angle information to estimate the position of the another information processing device. Thus, there is an effect that the direction of the another information processing device is calculated on the basis of the angle information and that the position of the another information processing device is estimated.

In the embodiment, the estimation unit may calculate reliability regarding the calculated direction of the another information processing device on the basis of the angle information. Thus, there is an effect the reliability regarding the calculated direction of the another information processing device is calculated on the basis of the angle information.

In the embodiment, the information regarding the beam may include received signal intensity at the time of the wireless communication. The estimation unit may calculate a distance between the information processing device and the another information processing device on the basis of the received signal intensity to estimate the position of the another information processing device. Thus, there is an effect that the distance between the information processing device and the another information processing device is calculated on the basis of the received signal intensity and that the position of the another information processing device is estimated.

In the embodiment, the information processing device may further include a control unit that displays display information for specifying the estimated position of the another information processing device on a display portion. Thus, there is an effect that the display information for specifying the estimated position of the another information processing device is displayed.

In the embodiment, the control unit may display information regarding a location at which the another information processing device is installed and the display information which are associated with each other. Thus, there is an effect that the information regarding the location at which the another information processing device is installed and the display information, which are associated with each other, are displayed.

In the embodiment, the control unit may display the display information so as to overlap an image generated by an imaging unit. Thus, there is an effect that the display information is displayed so as to overlap the image generated by the imaging unit.

In the embodiment, the control unit may display at least one of a mark indicating a direction of the another information processing device in a case based on a position of the information processing device and a mark indicating a distance between the information processing device and the another information processing device, as the display information, on the display portion. Thus, there is an effect that at least one of the mark indicating the direction of the another information processing device and the mark indicating the distance between the information processing device and the another information processing device is displayed as the display information.

In the embodiment, the estimation unit may calculate reliability regarding the calculated direction of the another information processing device on the basis of the angle information. The control unit may change a display mode of the display information on the basis of the calculated reliability. Thus, there is an effect that the display mode of the display information is changed on the basis of the calculated reliability.

In the embodiment, the information processing device may further include a control unit that records communication state information in which the estimated position of the another information processing device and information regarding a state of wireless communication performed with the another information processing device are associated with each other. Thus, there is an effect that the communication state information in which the estimated position of the another information processing device and the information regarding the state of the wireless communication performed with the another information processing device are associated with each other, is recorded.

In the embodiment, the information processing device may further include a control unit that displays the estimated position of the another information processing device and information regarding a state of wireless communication performed with the another information processing device which are associated with each other. Thus, there is an effect that the estimated position of the another information processing device and the information regarding the state of the wireless communication performed with the another information processing device, which are associated with each other, are displayed.

In the embodiment, the information processing device may further include a control unit that transmits information regarding the estimated position of the another information processing device to the another information processing device. Thus, there is an effect that the information regarding the estimated position of the another information processing device is transmitted to the another information processing device.

In the embodiment, the information processing device may further include a positional information acquisition unit that acquires positional information regarding a position of the information processing device. The control unit may calculate positional information regarding a position of the another information processing device on the basis of the acquired positional information and the estimated position of the another information processing device, and transmit the calculated positional information to the another information processing device. Thus, there is an effect that the positional information regarding the position of the another information processing device is calculated on the basis of the acquired positional information and the estimated position of the another information processing device and that the calculated positional information is transmitted to the another information processing device.

In the embodiment, wireless communication using a high frequency band may be performed with another information processing device. Thus, there is an effect that the wireless communication using the high frequency band is performed with the another information processing device.

According to the embodiment of the present disclosure, an excellent effect of estimating the position of another information processing device using wireless communication can be achieved.

### BRIEF DESCRIPTION OF THE DRAWINGS

FIG. 1 is a block diagram illustrating a functional configuration example of an information processing device according to a first embodiment of the present disclosure;

FIGS. 2A and 2B are simplified perspective views of an installation example of an antenna according to the first embodiment of the present disclosure;

FIGS. 3A and 3B are schematic diagrams illustrating a state where radio waves are transmitted and received by an antenna according to the first embodiment of the present disclosure;

FIGS. 4A and 4B are schematic diagrams illustrating an application example of beam forming using an information processing device according to the first embodiment of the present disclosure;

FIGS. 5A and 5B are diagrams illustrating a relationship between angle information and a beam which are used for estimation using an estimation unit according to the first embodiment of the present disclosure;

FIG. 6 is a graph corresponding to a theoretical formula of a propagation loss used for an estimated distance calculation process using the estimation unit according to the first embodiment of the present disclosure;

FIG. 7 is a diagram illustrating a usage example of the information processing device according to the first embodiment of the present disclosure;

FIG. 8 is a diagram illustrating a display example (store information list display screen) of a list of pieces of store information displayed on a display portion according to the first embodiment of the present disclosure;

FIG. 9 is a diagram illustrating a display example (store information display screen) of store information displayed on the display portion according to the first embodiment of the present disclosure;

FIG. 10 is a diagram illustrating a display example (store information display screen) of store information displayed on the display portion according to the first embodiment of the present disclosure;

FIG. 11 is a flow chart illustrating an example of a process procedure of a store information display process using the information processing device according to the first embodiment of the present disclosure;

FIG. 12 is a flow chart illustrating an estimation process in the process procedure of the store information display process using the information processing device according to the first embodiment of the present disclosure;

FIG. 13 is a flow chart illustrating an example of a process procedure of a terminal information display process using an information processing device according to the first embodiment of the present disclosure;

FIG. 14 is a block diagram illustrating a functional configuration example of an information processing device according to a second embodiment of the present disclosure;

FIG. 15 is a diagram illustrating a display example (store information display screen) of store information displayed on a display portion according to the second embodiment of the present disclosure;

FIG. 16 is a diagram illustrating a configuration example of a communication system according to a third embodiment of the present disclosure;

FIG. 17 is a schematic diagram of measurement information stored in a storage unit according to the third embodiment of the present disclosure;

FIG. 18 is a diagram illustrating a display example of communication state information displayed on a display portion according to the third embodiment of the present disclosure;

FIG. 19 is a flow chart illustrating an example of a process procedure of a measurement information recording process using an information processing device (parent device) according to the third embodiment of the present disclosure;

FIGS. 20A and 20B are diagrams illustrating a configuration example of a communication system and a position estimation example of another information processing device according to a fourth embodiment of the present disclosure; and

FIG. 21 is a flow chart illustrating an example of a process procedure of a positional information transmission process using an information processing device (parent device) according to the fourth embodiment of the present disclosure.

### DETAILED DESCRIPTION OF EMBODIMENTS

Hereinafter, embodiments for implementing the present disclosure (hereinafter, referred to as embodiments) will be described. The description thereof is performed in the following order.

1. First Embodiment (position estimation control: an example in which the position of a store is estimated to display a mark indicating a direction of the store and a distance to the store)

2. Second Embodiment (position estimation control: an example in which the position of a store is estimated to display a mark indicating a direction of the store and a distance to the store on an image or a map)

3. Third Embodiment (position estimation control: an example in which position estimation of a child device around a parent device and a communication state of the child device are acquired to display a communication state around the parent device).

4. Fourth Embodiment (position estimation control: an example in which information of a child device, estimated using a parent device, is provided to the child device and is used in the child device)

### 1. First Embodiment

### Configuration Example of Information Processing Device

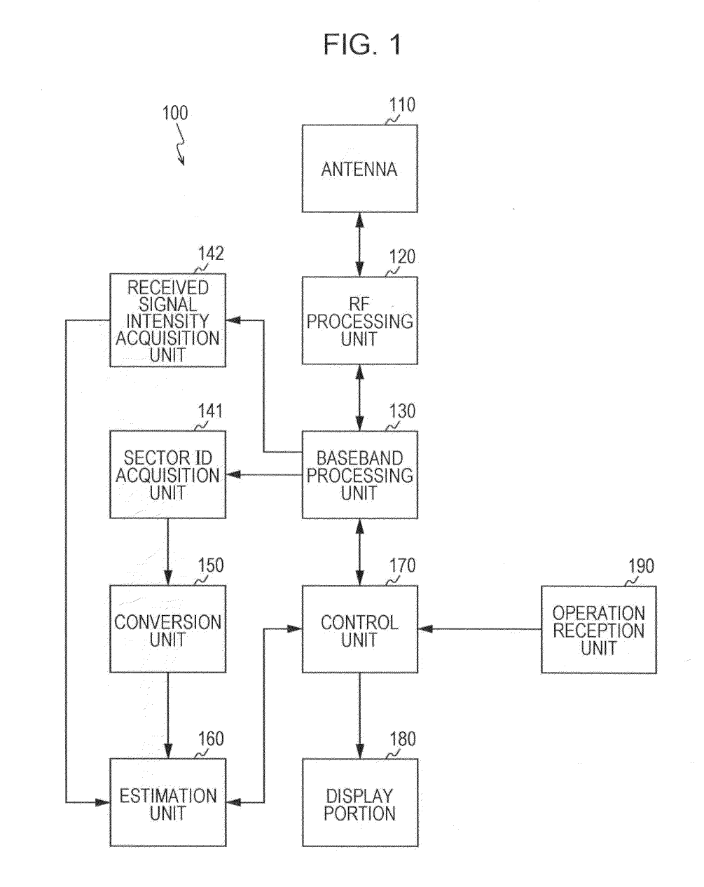

FIG. 1 is a block diagram illustrating a functional configuration example of an information processing device 100 according to a first embodiment of the present disclosure.

The information processing device 100 includes an antenna 110, a radio frequency (RF) processing unit 120, and a baseband processing unit 130. Meanwhile, the antenna 110, the RF processing unit 120, and the baseband processing unit 130 function as a wireless communication unit. Meanwhile, the antenna 110, the RF processing unit 120, and the baseband processing unit 130 are examples of a communication unit described in claims. In addition, the information processing device 100 includes a sector ID acquisition unit 141, a received signal intensity acquisition unit 142, a conversion unit 150, an estimation unit 160, a control unit 170, and a display portion 180.

In addition, the information processing device 100 is an information processing device capable of performing wireless communication using a 60-GHz band. In the wireless communication using the 60-GHz band, high-speed data communication can be performed. For example, in an IEEE802.11ad specification which is a wireless communication standard of a 60-GHz band, data communication of a maximum of 7 giga-bit per second (Gbps) can be performed.

In addition, for example, the information processing device 100 is a portable information processing device (for example, a smart phone, a mobile phone, or a tablet terminal) which has a wireless communication function.

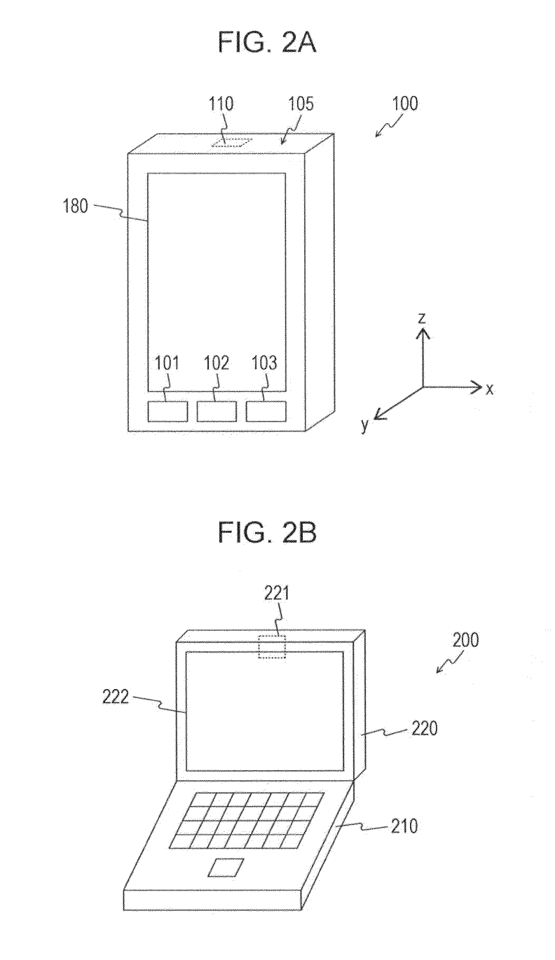

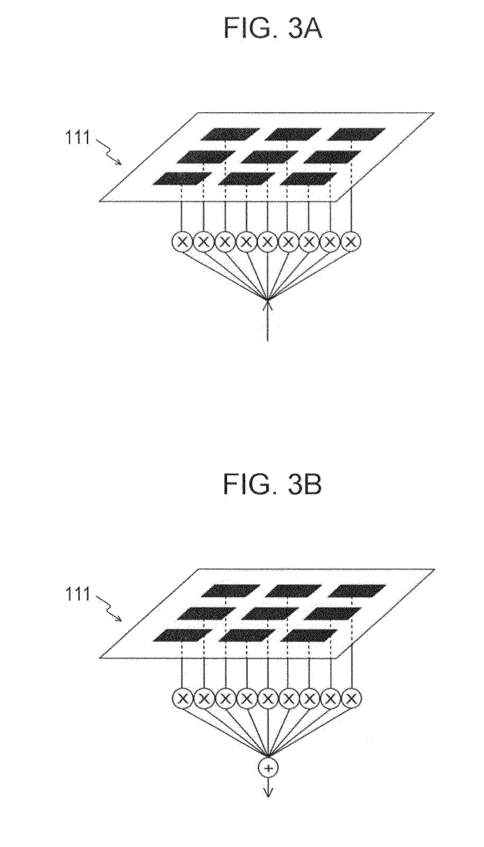

The antenna 110 is an antenna that transmits and receives radio waves (electromagnetic waves). Meanwhile, an installation example of the antenna 110 in the information processing device 100 will be described in detail with reference to FIGS. 2A and 2B. In addition, an example in which radio waves are transmitted and received by the antenna 110 will be described in detail with reference to FIGS. 3A and 3B to FIGS. 5A and 5B.

The RF processing unit 120 is a unit that performs an RF process on transmitted data (transmitted signal) and received data (received signal). That is, when transmitting data, the RF processing unit 120 modulates transmitted data on which a baseband process is performed by the baseband processing unit 130. The modulated transmitted data (RF signal) is transmitted as radio waves of a 60-GHz band from the antenna 110. In addition, when receiving data, the RF processing unit 120 demodulates data (received data converted from radio waves of 60-GHz band) which is received by the antenna 110, and outputs the demodulated received data (baseband signal) to the baseband processing unit 130.

The baseband processing unit 130 is a unit that performs a baseband process on transmitted data and received data on the basis of the control of the control unit 170. That is, when transmitting data, the baseband processing unit 130 performs a baseband process on transmitted data generated by the control unit 170, and outputs the transmitted data (baseband signal) on which the baseband process is performed to the RF processing unit 120. In addition, when receiving data, the baseband processing unit 130 performs a baseband process on the received data (baseband signal) which is output from the RF processing unit 120, and outputs the received data on which the baseband process is performed to the control unit 170.

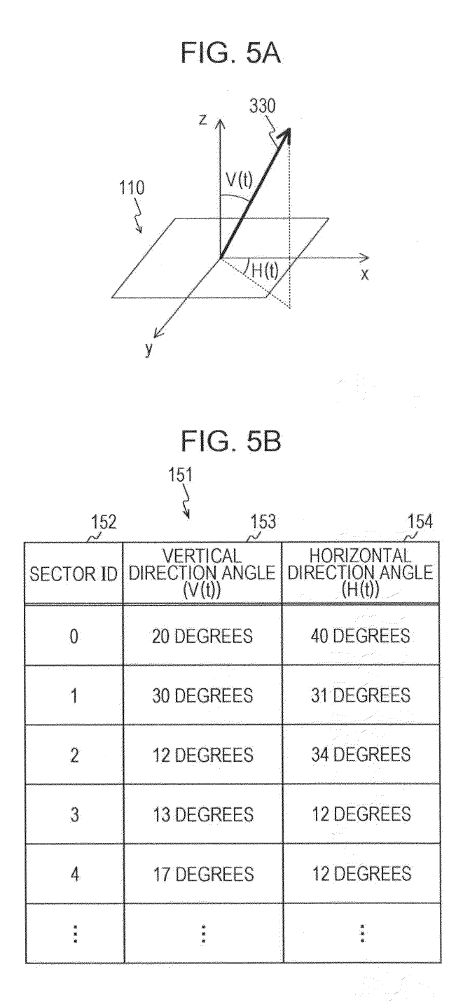

In addition, the baseband processing unit 130 controls a direction of a beam (transmitted beam, received beam) at the time of the transmission or reception of radio waves through the antenna 110, on the basis of the control of the control unit 170. In addition, the baseband processing unit 130 supplies a sector identifier (ID) for specifying the direction of the beam to the sector ID acquisition unit 141. Meanwhile the sector ID will be described in detail with reference to FIGS. 5A and 5B.

In addition, the baseband processing unit 130 is a unit that measures received signal intensity at the time of the reception of radio waves through the antenna 110 on the basis of the control of the control unit 170, and supplies the received signal intensity obtained by the measurement to the received signal intensity acquisition unit 142. Meanwhile, the received signal intensity means the intensity (received signal intensity) of a received signal (received signal transmitted within carrier wave frequency band) within a carrier wave frequency band (carrier wave band) which is used in wireless communication, when the transmission and reception of data is performed with another device using the wireless communication.

The sector ID acquisition unit 141 is a unit that acquires the sector ID at the time of the transmission or reception of radio waves through the antenna 110 from the baseband processing unit 130, and outputs the acquired sector ID to the conversion unit 150.

The received signal intensity acquisition unit 142 is a unit that acquires the received signal intensity at the time of the reception of radio waves through the antenna 110 from the baseband processing unit 130, and outputs the acquired received signal intensity to the estimation unit 160.

The conversion unit 150 is a unit that converts the sector ID output from the sector ID acquisition unit 141 into angle information, and outputs the angle information obtained by the conversion to the estimation unit 160. Meanwhile, the conversion from the sector ID into the angle information will be described in detail with reference to FIGS. 5A and 5B.

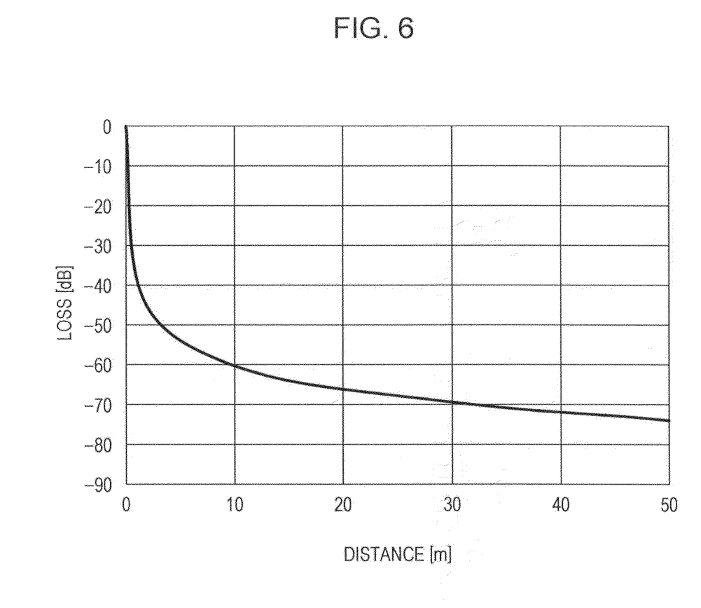

The estimation unit 160 is a unit that estimates the position of another information processing device on the basis of the angle information output from the conversion unit 150 and the received signal intensity output from the received signal intensity acquisition unit 142, and outputs an estimation result to the control unit 170. Meanwhile, the estimation will be described in detail with reference to FIGS. 5A and 5B and FIG. 6.

The control unit 170 is a unit that controls each unit of the information processing device 100 on the basis of various programs stored in a built-in memory. The control unit 170 is implemented by, for example, a central processing unit (CPU), a read only memory (ROM), or a random access memory (RAM).

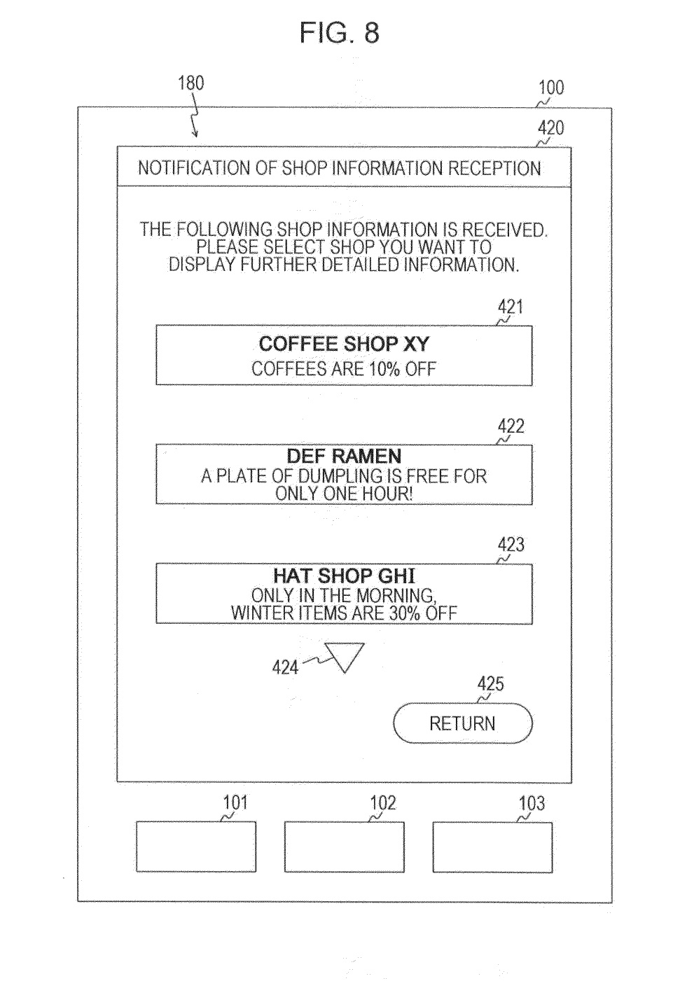

The display portion 180 is a display portion on which various images are displayed on the basis of the control of the control unit 170. For example, a display screen (for example, display screen illustrated in FIGS. 8 to 10) which is related to a shop is displayed on the display portion 180. Meanwhile, for example, a liquid crystal display (LCD) or an organic electro luminescence (EL) can be used as the display portion 180.

The operation reception unit 190 is an operation reception unit that receives an operation input performed by a user, and outputs operation information according to the received operation input to the control unit 170. For example, the operation reception unit 190 corresponds to operation members 101 to 103 illustrated in FIGS. 2A and 2B. In addition, the operation reception unit 190 and the display portion 180 can be configured as one body using a touch panel through which a user can perform an operation input by touching and approaching a display surface with his or her finger.

Installation Example of Antenna

FIGS. 2A and 2B are simplified perspective views of an installation example of the antenna according to the first embodiment of the present disclosure. Meanwhile, FIG. 2A illustrates an installation example of the antenna 110 in the information processing device 100. In addition, FIG. 2B illustrates an installation example of an information processing device 200 which is a modified example of the information processing device 100. Meanwhile, the information processing device 200 is, for example, a portable information processing device (for example, notebook type personal computer) which has a wireless communication function.

As illustrated in FIG. 2A, for example, it is possible to install the antenna 110 in one end surface (top surface 105) in a longitudinal direction in the information processing device 100. For example, when the information processing device 100 is a smart phone, as illustrated in FIG. 2A, the information processing device is often used by a user in a state where the longitudinal direction and vertical direction of the information processing device 100 are parallel to each other (or, state where information processing device is inclined forward with respect to user). For example, it is assumed that the user performs various operations using operation members (for example, display portion 180 (touch panel) and operation members 101 to 103) while viewing a display screen displayed on the display portion 180. Since the information processing device 100 is often used in such a state, it is preferable that the antenna 110 is disposed so that the transmission and reception surface of the antenna 110 faces the traveling direction thereof. Meanwhile, an x-axis, a y-axis, and a z-axis illustrated in FIG. 2A correspond to an x-axis, a y-axis, and a z-axis illustrated in FIG. 5A, respectively.

As illustrated in FIG. 2B, it is assumed that the information processing device 200 is a notebook type personal computer in which a first housing 210 including an operation reception unit and a second housing 220 including a display portion 222 are foldably connected with each other. In this case, it is possible to install an antenna 221 on an opposite surface (back surface) to a display surface of the display portion 222 of the second housing 220. In the back surface, it is preferable to install the antenna 110 at a position separated from a connecting portion between the first housing 210 and the second housing 220.

Example of Transmission and Reception of Radio Wave by Antenna

FIGS. 3A and 3B are schematic diagrams illustrating a state where radio waves are transmitted and received by the antenna 110 according to the first embodiment of the present disclosure.

First, a characteristic of the frequency of a 60-GHz band which is used in the embodiment of the present disclosure will be described.

With Regard to Characteristic of Frequency of 60-GHz Band

As described above, in the embodiment of the present disclosure, an example in which wireless communication is performed using a 60-GHz band is described. Here, the frequency of the 60-GHz band has a characteristic different from those of other bands that have been used hitherto in wireless communication. Meanwhile, other bands that have been used hitherto in wireless communication are, for example, an 800-MHz band (mobile phone or the like), a 2-GHz band (wireless local area network (WLAN), Bluetooth (registered trademark) or the like), or a 5-GHz band (WLAN or the like). For example, the frequency of the 60-GHz band has features of a high straight advancing property and a large absorption and attenuation property of radio waves in the atmosphere. In this manner, since the frequency of the 60-GHz band has a high straight advancing property, it is not possible to expect wraparound by diffraction when an obstacle is present. In addition, the frequency of the 60-GHz band does not move far due to its large attenuation. In this manner, when wireless communication using a 60-GHz band is performed, a communication range is limited.

With Regard to Beam Forming

As described above, since a communication range is limited in wireless communication using a 60-GHz band, a technique referred to as beam forming is adopted when the 60-GHz band is used. For example, this technique is also adopted in an IEEE802.11ad specification. This technique causes radio waves to move far by concentrating the radio waves in a specific direction when transmitting the radio waves. In addition, this technique is a technique capable of avoiding, if any, a shield by changing a direction in which the radio waves are concentrated, and capable of enabling communication by reflection.

The unsuitableness of the frequency of the 60-GHz band for wireless communication is overcome by adopting the beam forming. In addition, a similar effect is obtained by concentrating and receiving radio waves from a specific direction at the time of reception in addition to the time of transmission. In addition, the beam forming is performed using two information processing devices performing wireless communication, and thus the effect thereof can be enhanced. For example, the information processing device on the transmission side concentrates on transmission in a specific direction, and the information processing device on the reception side concentrates on reception from a specific direction. Here, the concentration in the specific direction is referred to as “beams”. In addition, in the beams, a beam to be transmitted is referred to as a transmitted beam, and a beam to be received is referred to as a received beam.

Mounting Method of Beam Forming

As a method of transmitting radio waves by concentration in a specific direction or a method of receiving radio waves by concentration from a specific direction, it is possible to use, for example, a phased array antenna 111 illustrated in FIGS. 3A and 3B. As illustrated in FIGS. 3A and 3B, the phased array antenna 111 is an antenna in which a plurality of antenna elements (illustrated as black rectangles) are disposed on a plane. Meanwhile, FIG. 3A illustrates a state where radio waves are transmitted by the antenna 110, and FIG. 3B illustrates a state where radio waves are received by the antenna 110.

As illustrated in FIG. 3A, when transmitting radio waves, in a step (which step it corresponds to is not distinguished in FIG. 3A) of a baseband signal or an RF signal, one transmitted signal is multiplied by a phase for each antenna element and is then transmitted from each antenna. Radio waves transmitted from the antennas cause phase interference by the spatial arrangement of the antenna elements, and thus strong radio waves are transmitted in a specific direction. The direction can be changed by a combination of the phases multiplied for the respective antennas.

As illustrated in FIG. 3B, when receiving radio waves, phases of radio waves received by the respective antennas by the spatial arrangement of the antenna elements are different from each other. With respect to the received radio waves, phases are multiplied for the respective antenna elements and then addition is performed in the step (which step it corresponds to is not distinguished in FIG. 3B) of the baseband signal or the RF signal, and thus radio waves received from a specific direction are strengthened by phase interference. The direction can be changed by a combination of the phases multiplied for the respective antennas.

In the beam forming, a wireless communication channel is ensured by controlling a combination of phases multiplied at the time of transmission or reception. Meanwhile, the control of the transmitted beam or the received beam by changing the combination is referred to as beam steering. In addition, each combination corresponds to a sector ID (sector ID 152 illustrated in FIG. 5B).

Application Example of Beam Forming

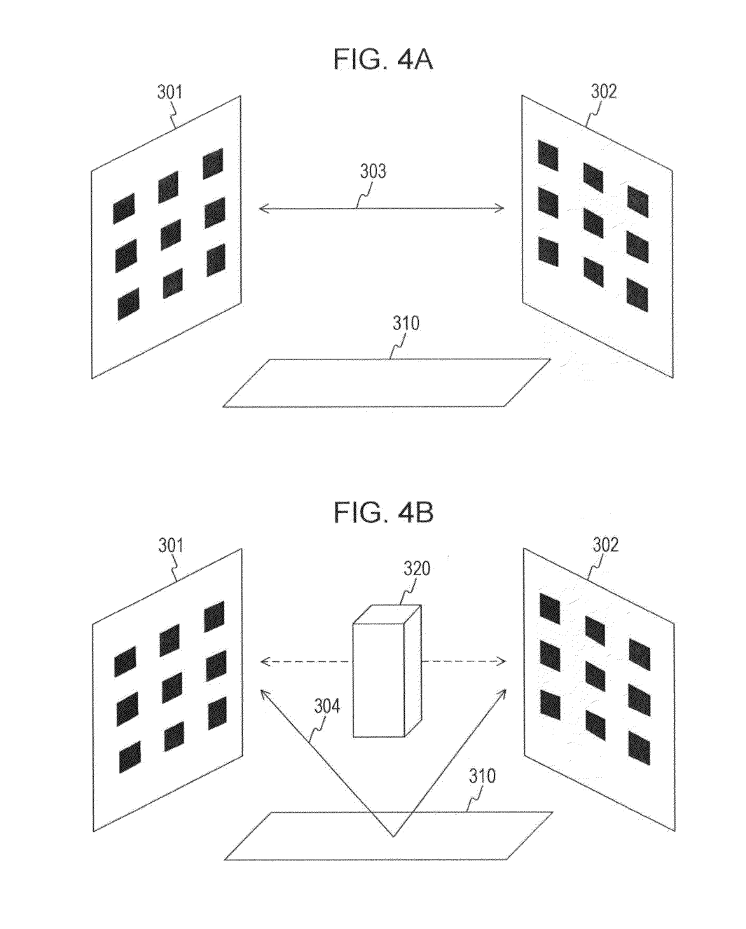

FIGS. 4A and 4B are schematic diagrams illustrating an application example of beam forming using the information processing device 100 according to the first embodiment of the present disclosure.

Each information processing device performing wireless communication performs beam steering in order to ensure a communication channel, and determines a transmitted beam or a received beam. The determination of the transmitted beam or the received beam is periodically performed even during wireless communication, and the transmitted beam or the received beam is selected depending on a change in a wireless environment.

Here, FIG. 4A schematically illustrates a state of a beam 303 in a case where an obstacle is not present between two information processing devices (between antennas 301 and 302 of two information processing devices) which perform wireless communication. As illustrated in FIG. 4A, when an obstacle is not present between the information processing devices performing wireless communication, the transmitted and received beam 303 is directed to each other's direction.

Here, FIG. 4B schematically illustrates a state of a beam 304 in a case where an obstacle 320 is present between two information processing devices (between antennas 301 and 302 of two information processing devices) which perform wireless communication. As illustrated in FIG. 4B, when the obstacle 320 is present between the information processing devices performing wireless communication, communication is ensured using reflected waves. For example, the transmitted and received beam 304 is reflected by a reflective plate 310. In this manner, when communication is ensured using reflected waves, the transmitted and received beam 304 is not directed to a direction of each other's information processing device. Meanwhile, when the obstacle 320 disappears between the two information processing devices performing wireless communication, a state returns to the state illustrated in FIG. 4A.

Here, for example, the switching of the beam is performed at any timing of a periodical timing and a case where the failure in wireless communication using a currently-used beam is detected. Meanwhile, the case where the failure in wireless communication is detected is a case where the failure is detected using, for example, an ACKowledgement (ACK) packet of a layer 2. In addition, when the switching of the beam is performed at any timing, a plurality of beams are tested, and thus an optimal beam is selected to recover the communication.

For example, in the case of the transmitted beam, a plurality of types of its own transmitted beams are transmitted as a trial, and a communication party reports a beam having the highest received signal intensity, and thus an optimal beam can be determined. In addition, in the case of the received beam, a communication party attempts a plurality of types of received beams of its own device while a transmitted beam is fixed, and sets a received beam having the highest received signal intensity as a received beam of its own device, and thus an optimal beam can be determined. Meanwhile, it is also possible to search for a further optimal beam by performing the above-described procedure a plurality of times.

In addition, it is also possible to perform switching of a beam while performing wireless communication. In this case, data (section for sending plurality of types of transmitted beams or section for trying plurality of types of received beams) which is necessary for beam switching is added to a data packet of wireless communication, and then the data having the data packet being added thereto is sent, and thus the wireless communication and the beam switching can be performed at the same time.

In this manner, the beam forming is used in order to ensure a wireless communication channel. Hereinafter, an example in which the position estimation of another information processing device is performed using information of beam forming will be described.

Example of Relationship Between Angle Information and Beam

FIGS. 5A and 5B are diagrams illustrating a relationship between angle information and a beam which are used for estimation using the estimation unit 160 according to the first embodiment of the present disclosure.

Here, FIG. 5A schematically illustrates a beam (transmitted beam or received beam) 330 in the antenna 110. In addition, in FIG. 5A, a transmission and reception surface in the antenna 110 is set to an xy coordinate, and a direction perpendicular to the transmission and reception surface in the antenna 110 is set to a z-axis direction.

In this case, an angle (angle of beam 330 in antenna 110) with respect to an x-axis direction in the xy coordinate is set to an angle H(t) of the beam 330 in the horizontal direction in the antenna 110. In addition, an angle (angle of beam 330 in antenna 110) with respect to the z-axis direction is set to an angle V(t) of the beam 330 in the vertical direction in the antenna 110.

FIG. 5B schematically illustrates conversion information 151 used for conversion using the conversion unit 150. The conversion information 151 is information (table) indicating an example of a relationship between the sector ID 152 and angle information (vertical direction angle V(t) 153 and horizontal direction angle H(t) 154).

Here, the sector ID 152 is information for specifying a combination (combination of phases multiplied for respective antennas) of phases for forming a beam used for wireless communication. That is, the sector ID 152 is information for specifying a direction of a beam. In addition, the sector ID 152 and the angle information (vertical direction angle V(t) 153 and horizontal direction angle H(t) 154) are associated with each other. Meanwhile, the conversion information 151 is unique information that is set for each information processing device. Meanwhile, in FIG. 5B, for convenience of description, relatively simple numerical numbers are shown as the vertical direction angle V(t) 153 and the horizontal direction angle H(t) 154.

Calculation Example of Direction of Another Information Processing Device and Distance to Another Information Processing Device

Here, a method of calculating a direction of another information processing device and a distance to another information processing device in a case based on the information processing device 100 will be described.

Calculation Example of Direction of Another Information Processing Device

First, a method of calculating a direction of another information processing device in a case based on the information processing device 100 will be described.

The information processing device 100 can estimate the position of another information processing device on the basis of information of beam forming. Here, the beam forming is implemented in order to perform stable wireless communication, but it is also possible to set a direction of a transmitted beam or a received beam to a direction of a communication party. However, the beam forming is not originally intended to be used for position estimation. For this reason, for example, it is also assumed that it is difficult to set the direction of the transmitted beam or the received beam to a direction of a communication party.

For example, as illustrated in FIG. 4B, when a wireless section has an obstacle, the information processing device 100 switches to a different beam in order to maintain wireless communication. In this case, when a direction of a beam is set to the direction of the communication party as it is, a direction different from a direction of a real communication party is set to the direction of the communication party.

For example, since commercial facilities or the like are used by many people, often an obstacle gets between another information processing device and the information processing device 100, and thus the switching of a beam is assumed to frequently occur.

Incidentally, it is possible to appropriately perform position estimation even in an environment where an obstacle moves around in a wireless communication section by performing calculation using an estimation method described below.

Specifically, the sector ID acquisition unit 141 acquires the sector ID 152 (illustrated in FIG. 5B) from the baseband processing unit 130.

Subsequently, the conversion unit 150 converts the sector ID 152 (illustrated in FIG. 5B) which is acquired by the sector ID acquisition unit 141 into real angle information (vertical direction angle V(t) 153 and horizontal direction angle H(t) 154 (illustrated in FIG. 5B)). The conversion is performed using the conversion information 151 illustrated in FIG. 5B.

Here, t is a value for specifying an order of data on a time axis. That is, the value t becomes a value indicating past data whenever the number increases like t=0, 1, 2, . . . . For example, a vertical direction angle V(0) and a horizontal direction angle H(0) indicate angle information corresponding to a sector ID that are acquired lately. In addition, a vertical direction angle V(1) and a horizontal direction angle H(1) indicate angle information corresponding to a sector ID that is acquired immediately before the vertical direction angle V(0) and the horizontal direction angle H(0). Similarly, a vertical direction angle V(2) and a horizontal direction angle H(2) indicate angle information corresponding to a sector ID that is acquired immediately before the vertical direction angle V(1) and the horizontal direction angle H(1).

Meanwhile, in a transmitted beam and a received beam, beam angles may be different from each other by the spatial arrangement of the antenna elements even with respect to the same sector ID. For this reason, as a method of converting a transmitted beam and a method of converting a received beam, different conversion methods may be used.

Subsequently, the estimation unit 160 estimates a direction of an information processing device of a connection destination in a case based on the information processing device 100 by using angle information obtained by the conversion unit 150. Specifically, the estimation unit 160 sequentially holds the angle information obtained by the conversion unit 150. Subsequently, the estimation unit 160 calculates an estimated value in each of a vertical direction and a horizontal direction on the basis of the held angle information. That is, pieces of information acquired at a plurality of timings are combined with each other in a time axis, and thus relative positional information of a communication party based on the information processing device 100 is estimated.

Specifically, the estimation unit 160 calculates an estimated value Est_V in a vertical direction using Expression 1 below. In addition, the estimation unit 160 calculates an estimated value Est_H in a horizontal direction using Expression 2 below.

Est_{—}V=(V(0)×W1(0)+V(1)×W1(1)+ . . . +V(n−1)×W1(n−1))/n Expression 1

Est_{—}H=(H(0)×W2(0)+H(1)×W2(1)+ . . . +H(n−1)×W2(n−1))/n Expression 2

Here, n denotes a number of pieces of data to be used. In addition, W1(t) and W2(t) denote a weighted value. For example, a fixed value (for example, W1(t)=1 and W2(t)=1) can be used as W1(t) and W2(t). In addition, a variable value (for example, older data has smaller value) according to an order on a time axis can be used as W1(t) and W2(t).

In addition, a variable value according to received signal intensity can be used as W1(t) and W2(t). For example, as the value of the received signal intensity increases, W1(t) and W2(t) can be set to a large value, and as the value of the received signal intensity decreases, W1(t) and W2(t) can be set to a small value.

In addition, a variable value according to a success rate of data communication can be used as W1(t) and W2(t). For example, when data communication succeeds, W1(t) and W2(t) are set to a large value (for example, 1), and when data communication fails, W1(t) and W2(t) are set to a small value (for example, 0.5).

In addition, each combination of these may be used as values for W1(t) and W2(t).

In addition, as angle information (vertical direction angle V(t) and horizontal direction angle H(t)), angle information obtained on the basis of a transmitted beam may be used, or angle information obtained on the basis of a received beam may be used. In addition, as angle information (vertical direction angle V(t) and horizontal direction angle H(t)), both angle information obtained on the basis of a transmitted beam and angle information obtained on the basis of a received beam may be used.

In addition, the estimation unit 160 estimates the reliability of the calculated estimated values (estimated value Est_V in vertical direction and estimated value Est_H in horizontal direction). For example, the reliability is defined by a mean square error between the estimated value (estimated angle) and each piece of angle information obtained on the basis of a beam (transmitted beam or received beam). The reliability is a value meaning that if the value of the reliability is small, the reliability is high, and that if the value of the reliability is large, the reliability is low.

Specifically, the estimation unit 160 calculates reliability Est_R_V in a vertical direction using Expression 3 below. In addition, the estimation unit 160 calculates reliability Est_R_H in a horizontal direction using Expression 4 below.

Est_{—}R_{—}V=((V(0)−Est_{—}V)²+(V(1)−Est_{—}V)²+ . . . +(V(n−1)−Est_{—}V)²)/n Expression 3

Est_{—}R_{—}H=((H(0)−Est_{—}H)²+(H(1)−Est_{—}H)²+ . . . +(H(n−1)−Est_{—}H)²)/n Expression 4

Calculation Example of Distance to Another Information Processing Device

Next, a method of calculating a distance to another information processing device in a case based on the information processing device 100 will be described.

The estimation unit 160 estimates a distance between the information processing device 100 and another information processing device on the basis of the received signal intensity acquired by the received signal intensity acquisition unit 142. First, the estimation unit 160 calculates estimated received signal intensity Est_S using Expression 5 below.

Est_{—}S=(S(0)×W3(0)+S(1)×W3(1)+ . . . +S(n−1)×W3(n−1))/n Expression 5

Here, n denotes a number of pieces of data to be used. In addition, S(t) denotes a value indicating received signal intensity at each time on a time axis. In addition, W3(t) denotes a weighted value. For example, a fixed value (for example, W3(t)=1) can be used as W3(t). In addition, a variable value (for example, older data has smaller value) according to an order on a time axis can be used as W3(t).

Subsequently, the estimation unit 160 calculates a distance (estimated distance) Est_D between the information processing device 100 and another information processing device using Expression 6 below on the basis of the calculated estimated received signal intensity Est_S.

Est_{—}D=Function_{—}A(Est_{—}S) Expression 6

Here, Function_A( ) denotes a function for performing conversion from the estimated received signal intensity Est_S into the estimated distance. The conversion method will be described in detail with reference to FIG. 6.

Conversion Example from Estimated Received Signal Intensity to Estimated Distance

FIG. 6 is a graph corresponding to a theoretical formula of a propagation loss used for an estimated distance calculation process using the estimation unit 160 according to the first embodiment of the present disclosure. That is, in FIG. 6, a graph showing a relationship between a propagation loss and a distance is illustrated.

In FIG. 6, a horizontal axis is an axis indicating a distance between the information processing device 100 and another information processing device. In addition, a vertical axis is an axis indicating a value of a propagation loss occurring between the information processing device 100 and another information processing device.

First, a relationship between received signal intensity and a distance will be described.

With regard to received signal intensity and a propagation loss, a relationship of Expression 7 below is established.

Received Signal Intensity=Transmission Power+Transmitting Antenna Gain+Reception Antenna Gain+Propagation Loss Expression 7

Here, the transmission power is a value defined by legal regulations. In addition, the transmitting antenna gain and the reception antenna gain are values determined by design, and become a substantially fixed value.

In addition, the propagation loss (propagation loss in free space) can be obtained by the following theoretical formula. In addition, the theoretical formula of the propagation loss corresponds to FIG. 6.

L [dB]=20×log(4πd/λ)

Meanwhile, π denotes a circular constant, λ denotes a wavelength (=(3×10⁸)/F[Hz]), and F denotes a frequency. In addition, d denotes a value indicating a distance between information processing devices in a free space.

Here, an example is described in which a distance between the information processing device 100 and another information processing device is calculated using a specific numerical value. For example, when the transmission power is set to 10 dBm, the transmitting antenna gain is set to 10 dBi, and the reception antenna gain is set to 10 dBi, it is assumed that the received signal intensity measured by the baseband processing unit 130 is “−30 dBm”.

In this case, the estimation unit 160 calculates a propagation loss of “−60 dB” using Expression 7. The estimation unit 160 calculates “10 m” as a distance between the information processing device 100 and another information processing device, using the theoretical formula (FIG. 6) of the propagation loss.

In this manner, wireless communication units (antenna 110, RF processing unit 120, and baseband processing unit 130) performs wireless communication using a specific band with another information processing device. The specific band is a high-frequency band (for example, 60-GHz band).

In addition, the estimation unit 160 estimates the position of another information processing device on the basis of information regarding a beam used during the wireless communication. Here, the information regarding a beam includes angle information for specifying at least one of a transmission direction of a transmitted beam used during the wireless communication and a reception direction of a received beam used during the wireless communication. In addition, the information regarding a beam includes received signal intensity at the time of the wireless communication.

Specifically, the estimation unit 160 calculates a direction of another information processing device in a case based on the position of the information processing device 100, on the basis of the angle information (vertical direction angle V(t) 153 and horizontal direction angle H(t) 154 (illustrated in FIG. 5B)). In this case, the estimation unit 160 can calculate the reliability regarding the calculated direction of another information processing device on the basis of the angle information. In addition, the estimation unit 160 calculates a distance between the information processing device 100 and another information processing device on the basis of received signal intensity. The estimation unit 160 can estimate the position (direction and distance of another information processing device) of another information processing device using these pieces of information.

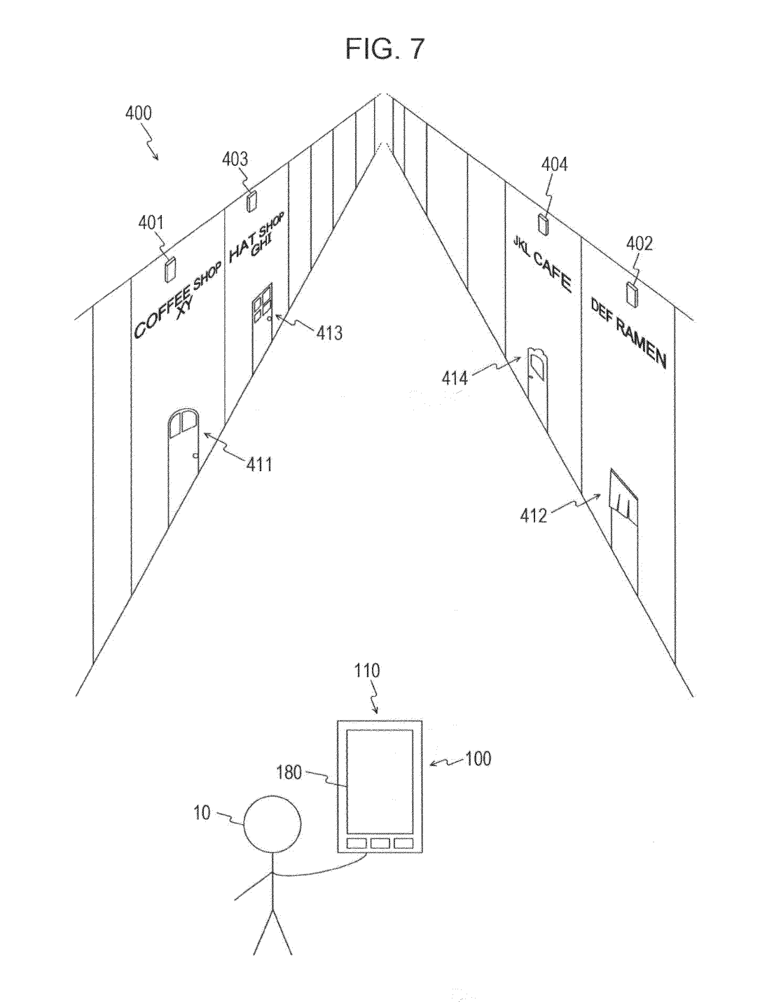

These estimation processes (for example, direction estimation process and distance estimation process) are simultaneously performed in parallel with a process of acquiring various pieces of information (for example, shop information) from another information processing device using wireless communication. In addition, pieces of information (direction of another information processing device and distance to another information processing device) which are obtained by these estimation processes can be provided to a user. This provision method will be described in detail with reference to FIGS. 7 to 10.

Usage Example of Information Processing Device

FIG. 7 is a diagram illustrating a usage example of the information processing device 100 according to the first embodiment of the present disclosure. In FIG. 7, a description is given on the assumption that a user 10 finds a desired shop while walking with the information processing device 100 in a commercial facility (shopping center ABC) 400.

As illustrated in FIG. 7, a plurality of shops (for example, coffee shop XY 411, DEF ramen 412, hat shop GHI 413, and JKL cafe 414) are present around the user 10 walking with the information processing device 100. In addition, information processing devices 401 to 404 capable of performing wireless communication using a 60-GHz band with the information processing device 100 are installed in the shops 411 to 414, respectively. For example, the information processing devices 401 to 404 can be installed (for example, installed so that transmission and reception surface of antenna is parallel to wall surface) along walls of the shops 411 to 414, respectively.

In addition, the information processing devices 401 to 404 transmit a beacon. In addition, the information processing devices 401 to 404 transmit information (shop information) regarding an installed shop to another information processing device connected thereto using wireless communication.

First, an initial connection process is performed. For example, when the information processing device 100 gets within the reach of the beacon in the commercial facility 400, the information processing device (for example, at least one of information processing devices 401 to 404) which transmits the beacon and the information processing device 100 are connected with each other. In this case, another information processing device and the information processing device 100 may be automatically connected with each other on condition that the information processing device 100 has received the beacon, or may be connected with each other on condition that the reception of the beacon is notified to and allowed by a user.

In addition, when the information processing device 100 receives a plurality of beacons, a user interface (UI) may automatically display pieces of shop information so that a user can select a desired shop. A display example in this case is illustrated in FIG. 8. In addition, when the information processing device 100 receives a plurality of beacons, a shop to be displayed may be automatically determined according to a certain rule. For example, a shop of the information processing device which transmits a beacon having the highest received signal intensity may be determined as a shop to be displayed. In addition, a connection operation may be performed by a user's startup of an application rather than an automatic manner.

Display Example of List of Pieces of Shop Information

FIG. 8 is a diagram illustrating a display example (shop information list display screen 420) of a list of pieces of shop information displayed on the display portion 180 according to the first embodiment of the present disclosure.

The shop information list display screen 420 is a display screen for displaying shop information (shop summary information) which is acquired from connected another information processing device using wireless communication. For example, as illustrated in FIG. 8, when pieces of shop information (for example, simple shop information (shop summary information)) regarding a plurality of shops are acquired, a list of these pieces of shop information is displayed.

For example, shop information selection regions 421 to 423, an arrow button 424, and a return button 425 are displayed on the shop information list display screen 420.

The shop information selection regions 421 to 423 are regions for selecting a shop for displaying further detailed shop information. For example, only some (for example, shop name and one-line advertising) of pieces of shop information regarding a shop to be displayed are displayed as shop summary information in the shop information selection regions 421 to 423.

The arrow button 424 is a button pressed down when displaying shops other than the shops displayed in the shop information selection regions 421 to 423. When the arrow button 424 is pressed down, shop information selection regions regarding other shops are sequentially displayed in response to the press-down operation.

The return button 425 is a button pressed down when displaying the previous screen.

For example, it is assumed that a selection operation (press-down operation) of any one of the shop information selection regions 421 to 423 is performed in the shop information list display screen 420. In this case, an information processing device which is installed in a shop corresponding to the selected shop information selection region is connected with the information processing device 100. The information processing device 100 acquires further detailed shop information from the information processing device connected thereto and displays the information.

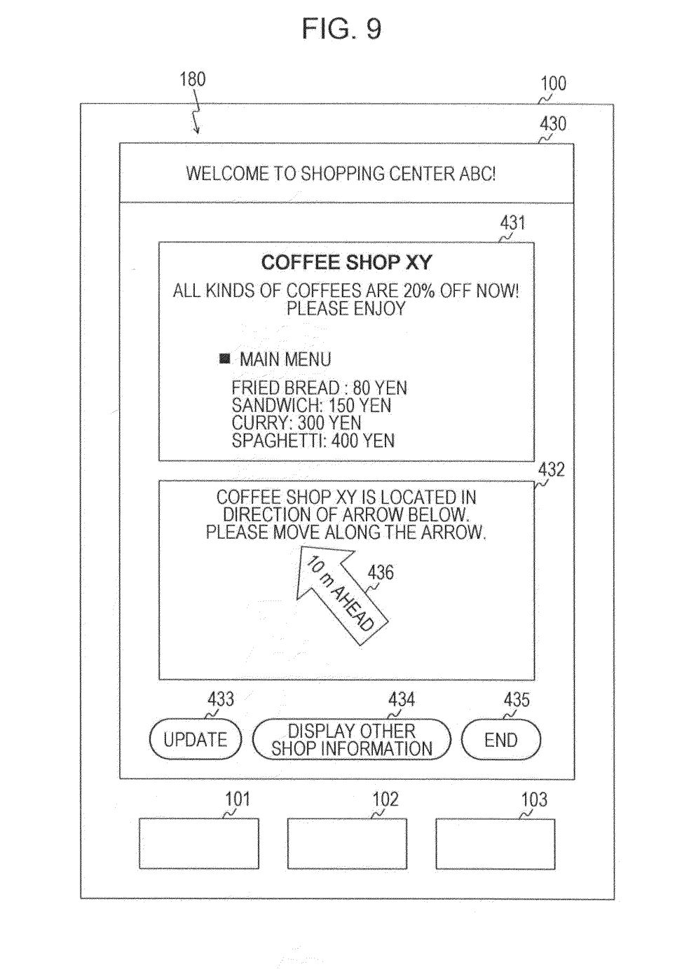

For example, when a selection operation (press-down operation) of the shop information selection region 421 (coffee shop XY) is performed in the shop information list display screen 420, the information processing device 401 installed in the coffee shop XY 411 is connected with the information processing device 100. The information processing device 100 acquires further detailed shop information (detailed shop information regarding coffee shop XY 411) from the information processing device 401 connected thereto and displays the information. The display example thereof is illustrated in FIG. 9.

Display Example of Shop Information

FIG. 9 is a diagram illustrating a display example (shop information display screen 430) of shop information displayed on the display portion 180 according to the first embodiment of the present disclosure.

The shop information display screen 430 is a display screen for displaying shop information (including information regarding commercial facility 400) which is acquired from another information processing device connected thereto using wireless communication. For example, when a selection operation (press-down operation) of the shop information selection region 421 (coffee shop XY) is performed in the shop information list display screen 420 illustrated in FIG. 8, shop information regarding the coffee shop XY 411 is displayed.

Meanwhile, when a shop to be displayed is automatically determined according to a certain rule, shop information regarding the determined shop is automatically displayed.

For example, a detailed shop information display region 431, an estimated shop position display region 432, au update button 433, another shop information display button 434, and an end button 435 are displayed on the shop information display screen 430.

The detailed shop information display region 431 is a region for displaying detailed shop information (for example, further detailed shop information than shop information of shop information selection regions 421 to 423 illustrated in FIG. 8). For example, all pieces of shop information regarding a shop to be displayed are displayed in the detailed shop information display region 431.

The estimated shop position display region 432 is a region for displaying display information for specifying a position regarding a shop of which the shop information is displayed in the detailed shop information display region 431. For example, a mark (for example, arrow 436 illustrated in FIG. 9) which indicates a direction of a shop in a case based on the position of the information processing device 100 is displayed in the estimated shop position display region 432. In addition, for example, a mark (for example, character within arrow 436 illustrated in FIG. 9) which indicates a distance to a shop in a case based on the position of the information processing device 100 is displayed in the estimated shop position display region 432.

Meanwhile, the direction of the shop (information processing device installed in shop) and the distance to the shop can be obtained by the above-described estimation processes (direction estimation process and distance estimation process). That is, the direction of the shop (information processing device installed in shop) is determined on the basis of the estimated value Est_V in the vertical direction and the estimated value Est_H in the horizontal direction. For this reason, the control unit 170 displays the mark (for example, arrow 436 illustrated in FIG. 9) which indicates the direction of the shop on the display portion 180, on the basis of the estimated value Est_V in the vertical direction and the estimated value Est_H in the horizontal direction.

Here, a relationship between the information processing device 100 and the antenna 110 is fixed. For this reason, if a direction of a shop with respect to the antenna 110 can be determined, a direction of an arrow displayed on the display portion 180 can be determined. That is, the direction (for example, arrow 436 illustrated in FIG. 9) of the shop displayed on the display portion 180 is determined by the estimated value Est_V in the vertical direction and the estimated value Est_H in the horizontal direction on the basis of a vertical direction with respect to a transmission and reception surface in the antenna 110.

Meanwhile, FIG. 9 illustrates an example in which a mark (for example, arrow 436 illustrated in FIG. 9) which indicates a direction of a shop is displayed on the basis of the estimated value Est_V in the vertical direction and the estimated value Est_H in the horizontal direction. However, a mark indicating a direction of a shop may be displayed using any one of the estimated value Est_V in the vertical direction and the estimated value Est_H in the horizontal direction. For example, it is possible to display a mark (for example, vertical arrow in display portion 180) which indicates a direction of a shop using the estimated value Est_V in the vertical direction. In addition, for example, it is possible to display a mark (for example, horizontal arrow in display portion 180) which indicates a direction of a shop using the estimated value Est_H in the horizontal direction.

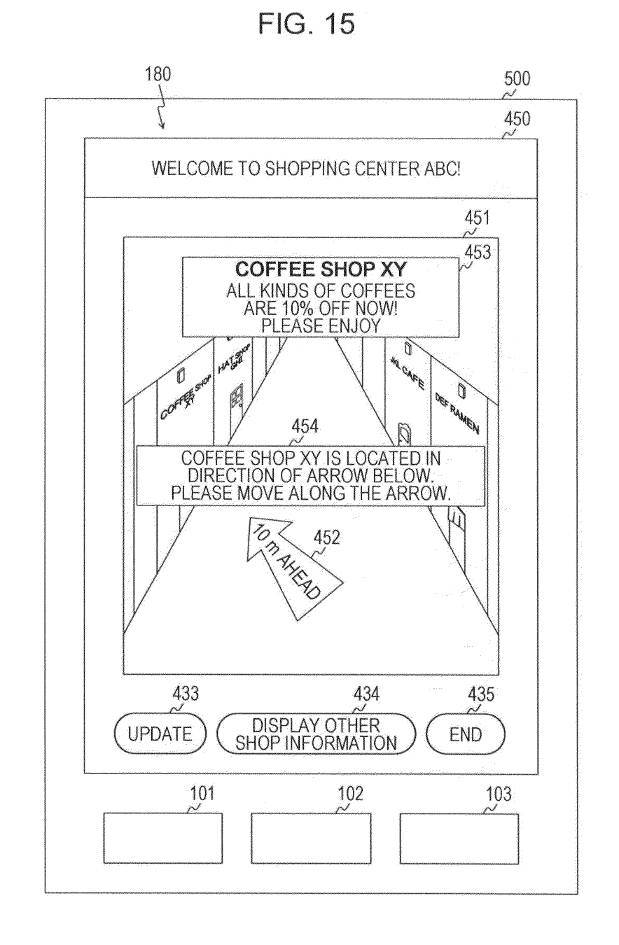

In addition, a mark indicating a direction of a shop may be displayed three-dimensionally (sterically) on the basis of the estimated value Est_V in the vertical direction and the estimated value Est_H in the horizontal direction. For example, like an arrow 452 illustrated in FIG. 15, a mark indicating a direction of a shop can be displayed three-dimensionally (sterically).

In addition, the control unit 170 displays a mark (for example, character within arrow 436 illustrated in FIG. 9) which indicates a distance to a shop on the display portion 180, on the basis of the distance to the shop (information processing device installed in shop) which is obtained by the estimation process. Meanwhile, FIG. 9 illustrates an example in which a numerical value of a distance to a shop is displayed as a mark indicating the distance, but the distance to the shop may be displayed in another display mode. For example, the length of the arrow may be changed and displayed depending on the distance to the shop. In addition, for example, the color of the arrow may be changed and displayed depending on the distance to the shop.

In addition, for example, a mark indicating a direction of a shop may be changed and displayed on the basis of the reliability (reliability Est_R_V in vertical direction or reliability Est_R_H in horizontal direction) which is obtained by the estimation process. For example, the color of the arrow or the transparency of the arrow may be changed and displayed depending on the degree of the reliability. In addition, a mark to be displayed may be changed and displayed depending on the degree of the reliability. For example, when the reliability is lower than a threshold value, attention may be attracted by displaying that the reliability is low. In addition, when the reliability is lower than the threshold value, it may be displayed that it is difficult to estimate the position of a shop. In addition, when the reliability is lower than the threshold value, an instruction (for example, press-down operation of update button 433) to perform a follow-up estimation process may be prompted by displaying that the reliability is low.

The update button 433 is a button pressed down when updating contents displayed in the detailed shop information display region 431 and the estimated shop position display region 432. When the press-down operation of the update button 433 is performed, shop information regarding a shop in a selection state is acquired again, and the above-described estimation processes (direction estimation process, distance estimation process, and reliability calculation process) are performed again. The display of the detailed shop information display region 431 is updated by the acquired shop information, the display of the estimated shop position display region 432 is updated on the basis of pieces of information that are newly obtained by the estimation process.

The other shop information display button 434 is a button pressed down when displaying shop information other than the shop information displayed in the detailed shop information display region 431 and the estimated shop position display region 432. For example, in a case where the shop information display screen 430 is displayed by selection operations of the shop information selection regions 421 to 423 in the shop information list display screen 420 illustrated in FIG. 8, when the other shop information display button 434 is pressed down, the shop information list display screen 420 is displayed. On the other hand, when a shop to be displayed is automatically determined and shop information is automatically updated on the basis of a certain rule, a new shop is determined by a reception operation of a beacon, and the new shop information is automatically displayed.

The end button 435 is a button pressed down when terminating the display of shop information.

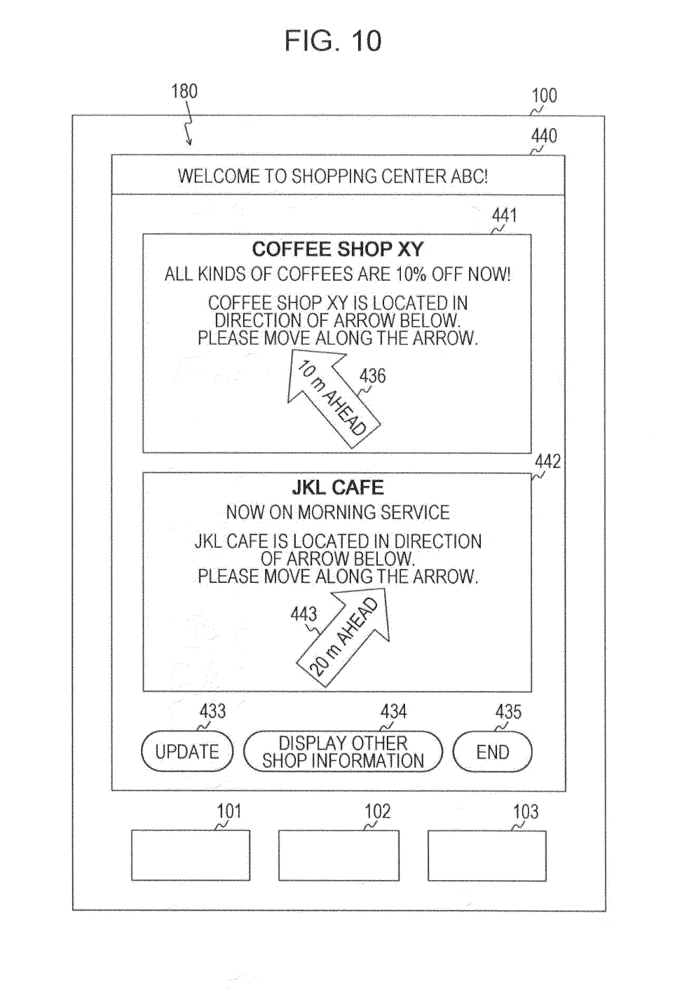

Meanwhile, FIG. 9 illustrates an example in which shop information regarding one shop and a mark (mark indicating direction of shop and distance to shop) are displayed. However, pieces of shop information regarding a plurality of shops and a mark (mark indicating direction of shop and distance to shop) may be displayed. The display example thereof is illustrated in FIG. 10.

Display Example of Shop Information

FIG. 10 is a diagram illustrating a display example (shop information display screen 440) of shop information displayed on the display portion 180 according to the first embodiment of the present disclosure. Meanwhile, since the shop information display screen 440 is a screen obtained by deforming a portion of the shop information display screen 430 illustrated in FIG. 9, portions in common with those of the shop information display screen 430 are denoted by the same reference numerals, and the description thereof will be partially omitted.

The shop information display screen 440 is a display screen on which estimated shop position display regions 441 and 442 regarding two shops are displayed. Meanwhile, the contents displayed in the detailed shop information display region 431 and the estimated shop position display region 432, which are illustrated in FIG. 9, are displayed in the estimated shop position display regions 441 and 442. In addition, an arrow 436 is the same as the arrow 436 illustrated in FIG. 9, and an arrow 443 corresponds to the arrow 436 illustrated in FIG. 9.

In this manner, when the estimated shop position display regions 441 and 442 regarding a plurality of shops are displayed, an acquisition process of shop information regarding each of the shops and the above-described estimation processes (direction estimation process and distance estimation process) are sequentially performed. Then, the acquired shop information and information obtained by the estimation processes are sequentially displayed.

In this manner, the control unit 170 displays display information (for example, arrow 436 illustrated in FIG. 9 and FIG. 10, and arrow 443 illustrated in FIG. 10) for specifying the position of another information processing device, which is estimated by the estimation unit 160, on the display portion 180. For example, the control unit 170 can display information (for example, shop information) regarding a location where another information processing device is installed and the display information which are associated with each other. In addition, the control unit 170 can display, as display information, at least one of a mark indicating a direction of another information processing device in a case based on the position of the information processing device 100 and a mark indicating a distance between the information processing device 100 and another information processing device.

In addition, the control unit 170 can change a display mode of the display information on the basis of the reliability calculated by the estimation unit 160. For example, a display mode of the display information can be changed by displaying the degree of the reliability or changing the color.

Meanwhile, FIG. 10 illustrates an example in which the estimated shop position display regions 441 and 442 regarding two shops are displayed, but estimated shop position display regions regarding three or more shops may be displayed.

In this manner, the information processing device 100 is connected to the information processing devices 401 to 404 installed in some shops, and thus information of the shop and information regarding the commercial facility 400 are displayed, and marks (for example, arrows) which indicate the positions of the shops are displayed. For this reason, a user can move to a desired shop while viewing shop information regarding the desired shop and a mark indicating the position of the shop. Thus, the user can easily reach the desired shop in the commercial facility 400. In addition, since pieces of shop information regarding the shops and the marks indicating the positions of the shops are sequentially displayed on the display portion 180 while shopping in the commercial facility 400, a user can enjoy finding a desired shop.

In addition, since an estimated value and a distance are calculated using a plurality of pieces of data (plurality of pieces of data of its own group), it is possible to prevent each value from being frequently changed. For example, it is possible to prevent a direction of a mark (for example, arrow) which indicates the position of a shop and the distance thereof from being frequently changed during a display.

Operation Example of Information Processing Device

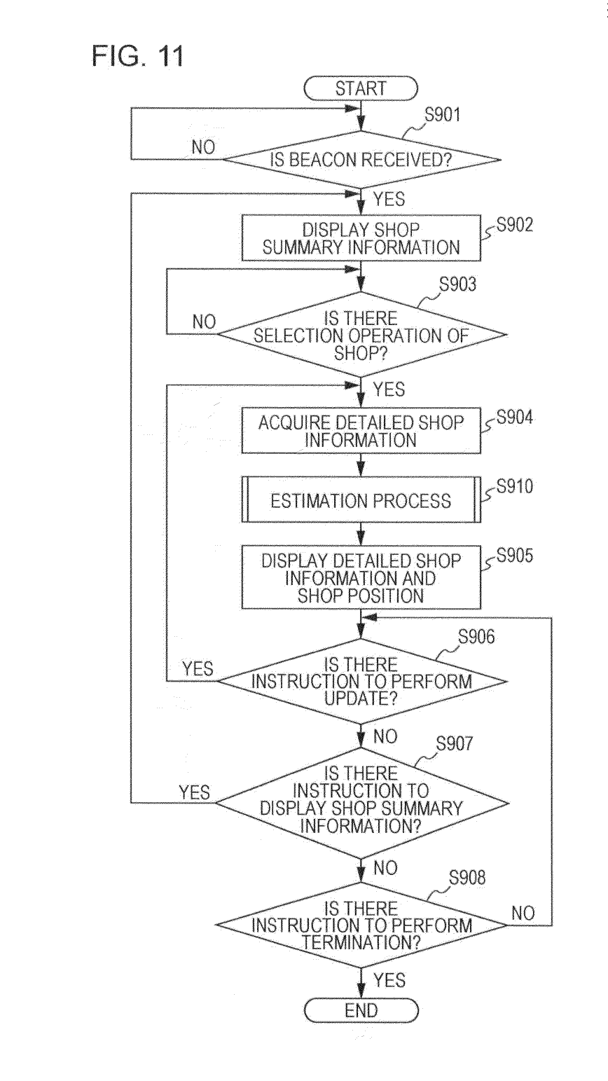

FIG. 11 is a flow chart illustrating an example of a process procedure of a shop information display process using the information processing device 100 according to the first embodiment of the present disclosure.

First, the control unit 170 determines whether a beacon is received (step S901). When the beacon is not received, the control unit continuously performs monitoring. On the other hand, when the beacon is received (step S901), the control unit 170 acquires shop summary information from an information processing device having transmitted the beacon using wireless communication, and displays the acquired shop summary information on the display portion 180 (step S902). In this case, when pieces of shop summary information are acquired from a plurality of information processing devices, these pieces of shop summary information are displayed. For example, the shop information list display screen 420 illustrated in FIG. 8 is displayed (step S902).

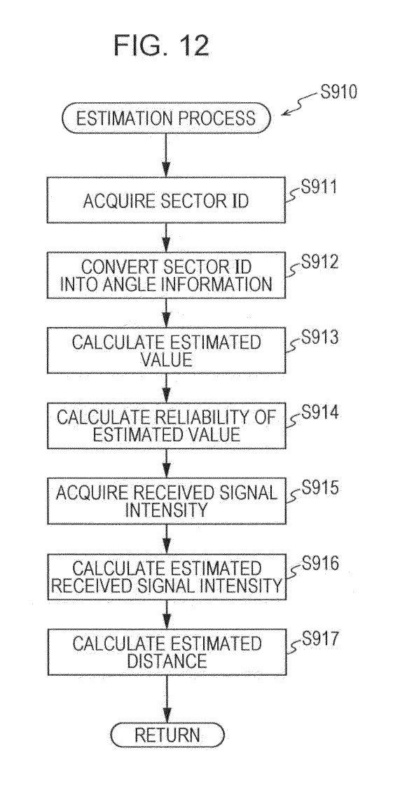

Subsequently, the control unit 170 determines whether a selection operation of a shop is performed (step S903). For example, it is determined whether the selection operations of the shop information selection regions 421 to 423 are performed in the shop information list display screen 420 illustrated in FIG. 8 (step S903). When the selection operation of the shop is not performed (step S903), monitoring is continuously performed. On the other hand, when the selection operation of the shop is performed (step S903), the control unit 170 acquires detailed shop information from an information processing device installed in the selected shop, using wireless communication (step S904). For example, the control unit 170 transmits a shop information request to the information processing device installed in the selected shop. Then, the detailed shop information is transmitted from the information processing device installed in the selected shop, in response to the shop information request. Subsequently, an estimation process is performed (step S910). The estimation process will be described in detail with reference to FIG. 12. Meanwhile, step S904 is an example of a communication procedure described in claims. In addition, step S910 is an example of an estimation procedure described in claims.

Subsequently, the control unit 170 displays the acquired detailed shop information and display information (information regarding position of shop) based on information obtained by the estimation process on the display portion 180 (step S905). For example, the shop information display screen 430 illustrated in FIG. 9 is displayed (step S905).

Subsequently, the control unit 170 determines whether an update instruction operation is performed (step S906). For example, it is determined whether the update button 433 is pressed down in the shop information display screen 430 illustrated in FIG. 9 (step S906). When the update instruction operation is performed (step S906), the process returns to step S904.

On the other hand, when the update instruction operation is not performed (step S906), the control unit 170 determines whether a display instruction operation is performed on shop summary information (step S907). For example, it is determined whether the other shop information display button 434 is pressed down in the shop information display screen 430 illustrated in FIG. 9 (step S907). When the display instruction operation is performed on the shop summary information (step S907), the process returns to step S902.

On the other hand, when the display instruction operation is not performed on the shop summary information (step S907), the control unit 170 determines whether a display termination operation of shop information is performed (step S908). For example, it is determined whether the end button 435 is pressed down in the shop information display screen 430 illustrated in FIG. 9 (step S908). When the display termination operation of the shop information is performed (step S908), the operation of the shop information display process is terminated. On the other hand, when the display termination operation of the shop information is not performed (step S908), the process returns to step S906.

FIG. 12 is a flow chart illustrating an estimation process (process procedure of step S910 illustrated in FIG. 11) in the process procedure of the shop information display process using the information processing device 100 according to the first embodiment of the present disclosure.

First, the sector ID acquisition unit 141 acquires a sector ID from the baseband processing unit 130 (step S911). Subsequently, the conversion unit 150 converts the sector ID acquired by the sector ID acquisition unit 141 into angle information (step S912).

Subsequently, the estimation unit 160 calculates estimated values (estimated value Est_V in vertical direction shown in Expression 1, and estimated value Est_H in horizontal direction shown in Expression 2) on the basis of the angle information obtained by the conversion unit 150 (step S913).

Subsequently, the estimation unit 160 calculates the reliability (reliability Est_R_V in vertical direction shown in Expression 3, and reliability Est_R_H in horizontal direction shown in Expression 4) of the calculated estimated values (step S914).

Subsequently, the received signal intensity acquisition unit 142 acquires received signal intensity (step S915). Subsequently, the estimation unit 160 calculates estimated received signal intensity (estimated received signal intensity Est_S shown in Expression 5) on the basis of the received signal intensity acquired by the received signal intensity acquisition unit 142 (step S916).

Subsequently, the estimation unit 160 calculates an estimated distance (estimated distance Est_D (distance between information processing device 100 and another information processing device) which is shown in Expression 6) on the basis of the calculated estimated received signal intensity (step S917).

Operation Example of Information Processing Device Installed in Shop

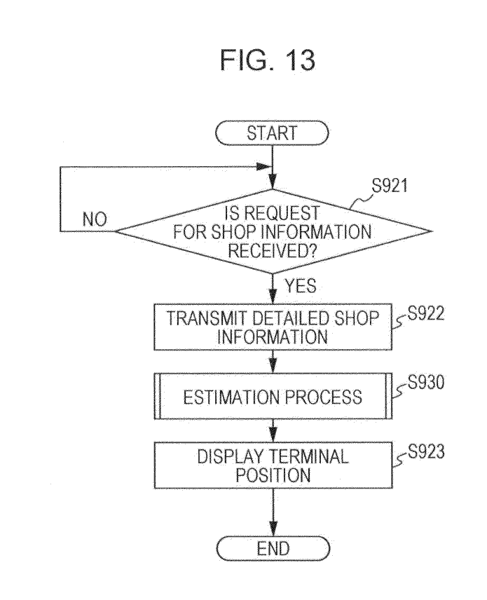

FIG. 13 is a flow chart illustrating an example of a process procedure of a terminal information display process using the information processing device 401 according to the first embodiment of the present disclosure. Meanwhile, since other information processing devices 402 to 404 installed in shops are operated in a similar manner to the information processing device 401, the description thereof will not be repeated here. In addition, the information processing device 401 has substantially the same configuration as the information processing device 100 illustrated in FIG. 1. For this reason, in this example, portions in common with those of the information processing device 100 will be described using the same reference numerals as those of the information processing device 100. In addition, the information processing device 401 sequentially transmits shop summary information to the information processing devices.

First, the control unit 170 of the information processing device 401 determines whether a shop information request is received (step S921). When the shop information request is not received, the control unit continuously performs monitoring. On the other hand, when the shop information request is received (step S921), the control unit 170 of the information processing device 401 transmits detailed shop information to the information processing device having transmitted the shop information request, using wireless communication (step S922). For example, when selection operations of the shop information selection regions 421 to 423 are performed in the shop information list display screen 420 illustrated in FIG. 8, a shop information request is transmitted.

Subsequently, an estimation process for estimating the position of the information processing device having transmitted the shop information request is performed (step S930). The estimation process is the same as the estimation process illustrated in FIG. 12 except that an information processing device on the transmission side of shop information and an information processing device on the reception side of the shop information are reversed, and thus the description thereof will not be repeated here.

Subsequently, the control unit 170 of the information processing device 401 displays a terminal position (position of information processing device of connection destination) on the display portion 180 of the information processing device 401, on the basis of the pieces of information (estimated value, reliability of estimated value, and estimated distance) which are obtained by the estimation process (step S923). For example, a terminal information display screen equivalent to the shop information display screen 430 illustrated in FIG. 9 is displayed.

In this manner, in the commercial facility 400, information regarding the position of the information processing device 100 that is moving can be displayed on the information processing device 401 on the shop side. Thus, for example, the shop can also easily ascertain the presence of a customer around the shop. In addition, for example, the shop can easily ascertain which user is viewing shop information regarding the shop among users around the shop. In addition, for example, the shop can easily ascertain the degree of congestion (for example, number of users who are interested in shop) around the shop.

Here, as a method of acquiring the position of a communication party, a method of using a radar device is used. The radar device generates radio waves or sound, and measures a position by measuring reflected waves from an object. However, this method asks for a dedicated device (radar device).

On the other hand, in the first embodiment of the present disclosure, it is possible to appropriately estimate the position of another information processing device on the basis of the directivity of beam forming and received signal intensity in 60 GHz wireless communication, without using a dedicated device for measuring a position. That is, it is possible to appropriately estimate the position of another information processing device using wireless communication. Thus, it is possible to reduce the cost and size of the information processing device 100.

In addition, in the first embodiment of the present disclosure, it is possible to simultaneously perform data communication using wireless communication and position estimation of another information processing device. Thus, it is possible to reduce time to estimate a position, and it is also possible to provide positional information to a user at a high speed.

In addition, in the first embodiment of the present disclosure, since an estimated value and a distance for estimating the position of another information processing device are calculated by using various coefficients, it is possible to acquire stable position estimation results.

In addition, in the first embodiment of the present disclosure, it is possible to provide a graphical user interface (GUI) that reflects estimation results of a position, a distance, and reliability.

### 2. Second Embodiment

In the first embodiment of the present disclosure, an example has been described in which a mark (for example, arrow) which indicates a direction of a shop and a distance to the shop are displayed and the position of the shop is notified to a user. Here, it is also considered that the mark (for example, arrow) which indicates a direction of a shop and a distance to the shop is displayed so as to be superimposed on an image (photo) generated by an imaging device, by applying, for example, augmented reality (AR). In addition, for example, it is also considered that the mark (for example, arrow) which indicates a direction of a shop and a distance to the shop is displayed so as to be superimposed on a map (for example, two-dimensional map or three-dimensional map) which includes the position of an information processing device.

Incidentally, in the second embodiment of the present disclosure, an example is described in which a mark indicating a direction of a shop and a distance to the shop is displayed on an image or a map and the position of the shop is notified to a user.

Configuration Example of Information Processing Device

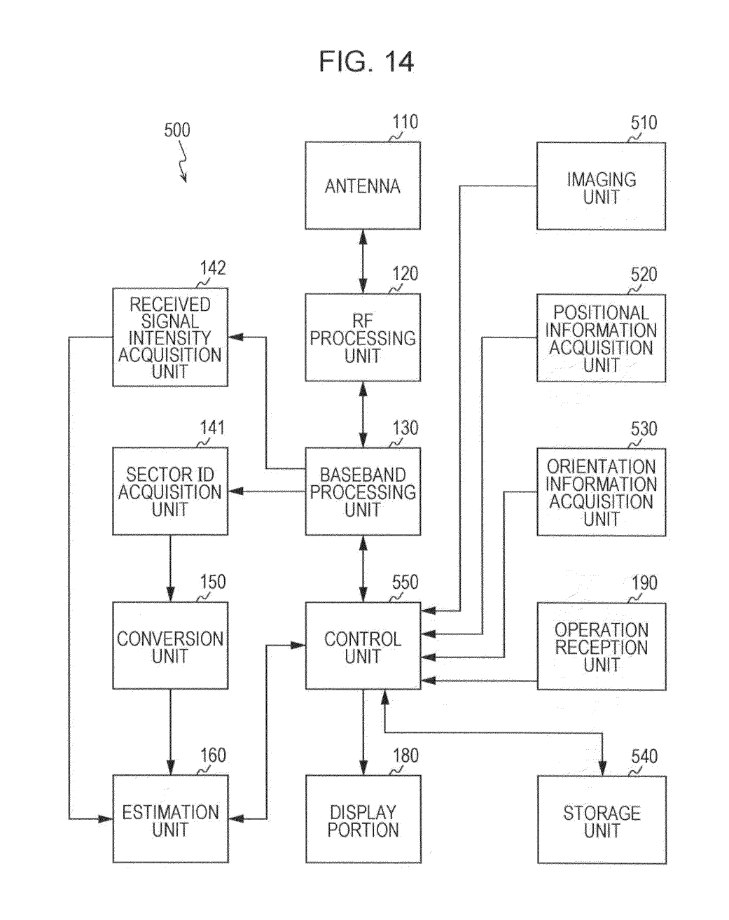

FIG. 14 is a block diagram illustrating a functional configuration example of an information processing device 500 according to the second embodiment of the present disclosure. Meanwhile, since the information processing device 500 is a device obtained by deforming a portion of the information processing device 100 illustrated in FIG. 1, portions in common with those of the information processing device 100 are denoted by the same reference numerals, and the description thereof will be partially omitted.

The information processing device 500 includes an imaging unit 510, a positional information acquisition unit 520, an orientation information acquisition unit 530, a storage unit 540, and a control unit 550.

The imaging unit 510 is a unit that generates image data by capturing a subject and outputs the generated image data to the control unit 550. The imaging unit 510 is constituted by, for example, an optical system (plurality of lenses), an imaging element, or a signal processing unit. Meanwhile, the optical system constituting the imaging unit 510 can be installed in a surface (for example, top surface 105 illustrated in FIG. 2A) in which an antenna 110 is installed. That is, it is possible to install the optical system constituting the imaging unit 510 so that an optical axis of the optical system constituting the imaging unit 510 is parallel to a vertical direction (for example, direction of z coordinate illustrated in FIG. 2A) with respect to a transmission and reception surface in the antenna 110.

The positional information acquisition unit 520 is a unit that acquires information (positional information) for specifying the position of the information processing device 500 and outputs the acquired positional information to the control unit 550. The positional information is absolute positional information, and is, for example, a latitude, a longitude, or an altitude. The positional information acquisition unit 520 is realized by, for example, a global positioning system (GPS) receiver that receives a GPS signal and calculates a latitude, a longitude, and an altitude. In addition, the positional information acquisition unit 520 may acquire positional information through an external network. For example, the positional information acquisition unit 520 can acquire positional information from another information processing device (for example, communication control unit operated by telecommunications carrier) through an external network. In addition, for example, the positional information acquisition unit 520 can acquire information (positional information) regarding a position which corresponds to identification information of a base station operated by a telecommunications carrier or an access point of a wireless local area network (LAN). Meanwhile, identification information of a base station of an information processing device is, for example, a sector ID, and identification information of an access point of a wireless LAN is, for example, a service set identifier (SSID). Meanwhile, the positional information may be acquired by other acquisition methods except for these acquisition methods.

The orientation information acquisition unit 530 is a unit that acquires information (orientation information (for example, angle in the case based on the north)) for specifying an orientation on the earth, and outputs the acquired orientation information to the control unit 550. The orientation information acquisition unit 530 is realized by a sensor that measures an orientation on the earth using, for example, terrestrial magnetism. The sensor is a magnetic field sensor constituted by a coil with two axes (for example, x-axis and y-axis), which are perpendicular to each other, and a magnetoresistive (MR) element disposed in a central portion of the coil. The MR element is an element that senses terrestrial magnetism and has a resistance value varying depending on the intensity of the terrestrial magnetism. A variation in resistance of the MR element is divided into components (for example, components of x-axis and y-axis) in two directions by the coil with two axes, and an orientation is calculated on the basis of a ratio of terrestrial magnetism between the components in two directions. Here, for example, the orientation information acquisition unit 530 measures an orientation in a vertical direction (for example, direction of z coordinate illustrated in FIG. 2A and FIG. 5A) with respect to the transmission and reception surface in the antenna 110. Meanwhile, an orientation may be acquired by other orientation acquisition methods except for the orientation acquisition method using the magnetic field sensor.

The storage unit 540 is a unit that stores various pieces of information on the basis of the control of the control unit 550, and supplies the stored information to the control unit 550.

The control unit 550 displays image data generated by the imaging unit 510 as a real-time moving image such as liveview on a display portion 180. In this case, the control unit 550 displays a mark indicating a direction of a shop and a distance to the shop so as to be superimposed on the real-time moving image. The display example thereof is illustrated in FIG. 15.

Display Example of Shop Information

FIG. 15 is a diagram illustrating a display example (shop information display screen 450) of shop information displayed on the display portion 180 according to the second embodiment of the present disclosure. Meanwhile, since the shop information display screen 450 is a screen obtained by deforming a portion of the shop information display screen 430 illustrated in FIG. 9, portions in common with those of the shop information display screen 430 are denoted by the same reference numerals, and the description thereof will be partially omitted.

The shop information display screen 450 is a display screen that displays shop information (including information regarding commercial facility 400) which is acquired from another information processing device connected thereto using wireless communication on an image 451 generated by the imaging unit 510.

For example, a user moves in a state where the top surface 105 (illustrated in FIG. 2A) of the information processing device 500 provided with the imaging unit 510 faces a traveling direction, and thus the user may display an image in the traveling direction on the display portion 180.

Meanwhile, an arrow 452 corresponds to the arrow 436 illustrated in FIG. 9. Meanwhile, the arrow 452 can be displayed three-dimensionally (sterically) depending on a direction of a shop. In addition, a shop information display region 453 corresponds to the detailed shop information display region 431 illustrated in FIG. 9, and an estimated shop position display region 454 corresponds to the estimated shop position display region 432 illustrated in FIG. 9.

In this manner, a mark (for example, arrow 452) which indicates a direction of a shop and a distance to the shop is displayed so as to be superimposed on the image (photo) 451 generated by the imaging unit 510, and thus a user can ascertain the position of a real shop more easily.

Meanwhile, in the above, an example has been described in which the mark indicating a direction of a shop and a distance to the shop is displayed so as to be superimposed on the image (photo) generated by the imaging unit 510. However, the mark (for example, arrow) which indicates a direction of a shop and a distance to the shop may be displayed so as to be superimposed on a map (for example, two-dimensional map or three-dimensional map) which includes the position of the information processing device 500.

For example, the storage unit 540 stores map data for displaying a map on the display portion 180. For example, the map data is data specified by a latitude and a longitude, and is divided into a plurality of regions using a certain latitude width and longitude width as units.

The control unit 550 acquires map data (map data including current position) from the storage unit 540 on the basis of the positional information acquired by the positional information acquisition unit 520, and displays a map corresponding to the acquired map data on the display portion 180. In this case, the control unit 550 displays a mark (mark of its own device) which indicates the position of the information processing device 500 on the map, on the basis of the positional information acquired by the positional information acquisition unit 520. In addition, the control unit 550 displays a mark (shop mark) which indicates the position of a shop on the map, on the basis of an orientation of the shop and a distance to the shop which are estimated by the estimation unit 160 and an orientation which is specified by the orientation information acquired by the orientation information acquisition unit 530. Meanwhile, the mark of its own device is, for example, an icon indicating the information processing device 500, and the shop mark is, for example, an icon indicating the shop. The control unit 550 displays a mark (for example, arrow) which indicates a route between the mark of its own device and the shop mark on the map. Meanwhile, the map data may be acquired from the outside through a network.

In this manner, a mark indicating a direction of a shop and a distance to the shop is displayed on an image or a map, and the position of the shop is notified to a user, and thus the user can ascertain the position of the shop more easily.

### 3. Third Embodiment

In the first and second embodiments of the present disclosure, an example has been described in which a mark (for example, arrow) which indicates a direction of a shop and a distance to the shop is displayed and the position of the shop is notified to a user. Here, as described above, in the frequency of a 60-GHz band, when an obstacle is present, a communication range is limited. In particular, in an environment having a fixed obstacle, a location that is not suitable for communication occurs even if means such as beam forming is used. For this reason, for example, when a user purchases a new information processing device (for example, digital versatile disk (DVD) player) and places the information processing device in his or her home, it is assumed to be difficult to determine where the information processing device is preferably disposed in his or her home. Therefore, it is important for a user to easily ascertain an appropriate location at which the information processing device is to be installed.

Incidentally, in the third embodiment of the present disclosure, an example is described in which position estimation of a child device around a parent device and a communication state of the child device are acquired and a communication state around the parent device is displayed.

Configuration Example of Communication System

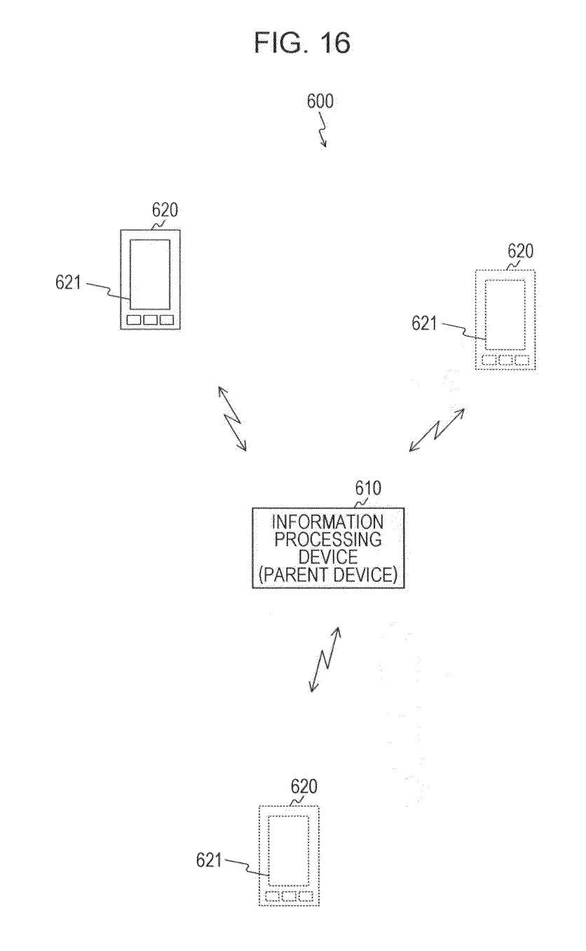

FIG. 16 is a diagram illustrating a configuration example of a communication system 600 according to the third embodiment of the present disclosure.

The communication system 600 includes an information processing device (parent device) 610 and an information processing device (child device) 620. The information processing device (parent device) 610 and the information processing device (child device) 620 are information processing devices capable of performing wireless communication using a 60-GHz band. In addition, the information processing device (parent device) 610 is an information processing device serving as a parent device, and the information processing device (child device) 620 is an information processing device serving as a child device.

In addition, the information processing device (parent device) 610 has the same configuration as the information processing device 500 illustrated in FIG. 14. For this reason, in the third embodiment of the present disclosure, a description will be given by attaching the same reference numerals as those of the information processing device 500 to portions in common with those of the information processing device 500.

The information processing device (parent device) 610 is, for example, an information processing device (for example, personal computer or printer connected to external circuit (LAN cable)) which is fixedly used.

The information processing device (child device) 620 is a portable information processing device (for example, smart phone, tablet terminal, or mobile phone). Meanwhile, in FIG. 16, a transition of the information processing device (child device) 620 that is moving is shown as a dotted line. In addition, the information processing device (child device) 620 can be connected to an external circuit through the information processing device (parent device) 610, and can be connected to the Internet.

Here, it is assumed that the information processing device (child device) 620 is connected to an external circuit through the information processing device (parent device) 610 and is connected to the Internet. In this case, the estimation unit 160 of the information processing device (parent device) 610 estimates a relative position of the information processing device (child device) 620 in a case based on the information processing device (parent device) 610 by the above-described estimation process. The relative position is, for example, a direction of the information processing device (child device) 620 in a case based on the information processing device (parent device) 610 and a distance between the information processing device (parent device) 610 and the information processing device (child device) 620.

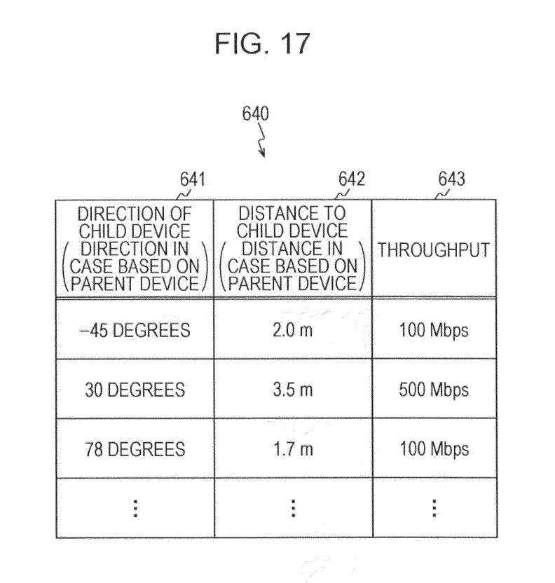

In addition, the control unit 550 of the information processing device (parent device) 610 measures the throughput of wireless communication units (antenna 110, RF processing unit 120, and baseband processing unit 130) at the same time as the estimation process. The control unit 550 of the information processing device (parent device) 610 records, in the storage unit 540, the relative position of the information processing device (child device) 620, which is estimated by the estimation unit 160, and the throughput obtained by the measurement which are associated with each other. Meanwhile, the throughput can be measured by a method of measuring a real communication rate. In addition, an example of measurement information stored in the storage unit 540 is illustrated in FIG. 17.

Storage Example of Measurement Information

FIG. 17 is a schematic diagram of measurement information 640 stored in the storage unit 540 according to the third embodiment of the present disclosure.

The measurement information 640 is information in which a direction 641 of a child device, a distance 642 to the child device, and a throughput 643 are associated with each other. Meanwhile, as described above, the direction 641 of the child device and the distance 642 to the child device are calculated by the estimation unit 160.

The direction 641 of the child device is a direction of the information processing device (child device) 620 in a case based on the information processing device (parent device) 610. For example, an angle of the information processing device (child device) 620 in a horizontal direction in a case where a vertical direction with respect to the transmission and reception surface in the antenna 110 of the information processing device (parent device) 610 is set to 0 degrees can be set to the direction 641 of the child device.

The distance 642 to the child device is a distance to the information processing device (child device) 620 in a case based on the information processing device (parent device) 610. For example, a distance from the transmission and reception surface in the antenna 110 of the information processing device (parent device) 610 can be set to the distance 642 to the child device.

The throughput 643 is a value obtained by measurement in a case where the information processing device (child device) 620 is connected to the Internet through the information processing device (parent device) 610 and an external circuit. For example, an average value of values measured for a predetermined period of time can be set to the throughput 643.

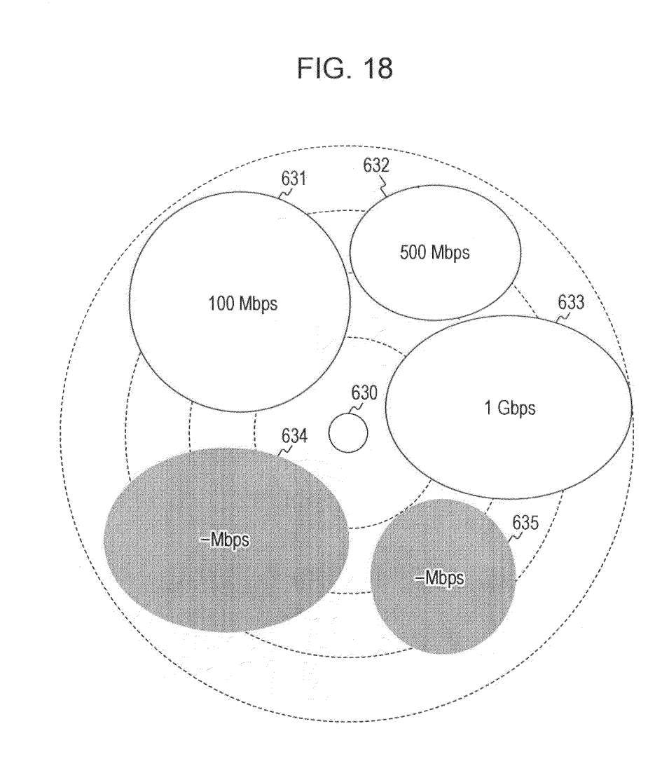

In addition, communication state information (throughput information) at a location where the information processing device (parent device) 610 is installed can be provided to a user on the basis of the measurement information 640 stored in the storage unit 540. For example, the communication state information can be provided to a user by being displayed on the display portion 180 of the information processing device (parent device) 610. The display example thereof is illustrated in FIG. 18.

Display Example of Communication State Information

FIG. 18 is a diagram illustrating a display example of the communication state information displayed on the display portion 180 according to the third embodiment of the present disclosure.

For example, the control unit 550 of the information processing device (parent device) 610 can display the communication state information (communication state map) illustrated in FIG. 18 on the display portion 180, on the basis of the measurement information stored in the storage unit 540. For example, as illustrated in FIG. 18, it is possible to display positional information and throughput which are associated with each other.

Here, a mark (white circle) 630 is a mark indicating the position of the information processing device (parent device) 610. In addition, dotted lines expanding with the white circle 630 as the center indicates a distance from the information processing device (parent device) 610.

In addition, marks (ellipses or circles) 631 to 635 are marks indicating ranges in which values of the throughput measured by the above-described measurement are the same (or substantially the same) as each other. That is, the ranges corresponding to the marks (ellipses or circles) 631 to 635 are ranges in which the values of the throughput are the same (or substantially the same) as each other. In addition, numerical values within the marks (ellipses or circles) 631 to 635 are values of the throughput measured by the above-described measurement.

Meanwhile, it is preferable that a range of unstable communication (or range in which only throughput having fixed value or less is measured) be set to a display mode (for example, set to gray) which is different from those of other ranges. FIG. 18 illustrates a case where the marks (ellipses or circles) 634 and 635 are in a range (or range in which only throughput having fixed value or less is measured) in which communication is not stable.

In this manner, the control unit 550 records, in the storage unit 540, the communication state information in which the position of the information processing device (child device) 620, which is estimated by the estimation unit 160, and information (for example, throughput) regarding a state of wireless communication performed with the information processing device (child device) 620 are associated with each other.

In addition, the control unit 550 displays the position of the information processing device (child device) 620, which is estimated by the estimation unit 160, and the information (for example, throughput) regarding a state of wireless communication performed with the information processing device (child device) 620 which are associated with each other, on the display portion 180.

In this manner, the estimated position of the information processing device (child device) 620 and the past communication state at the position are combined with each other and stored, and thus it is possible to generate information (communication state information) indicating a range in which communication can be performed with the information processing device (parent device) 610. In addition, the communication state information (map information) is provided to a user, thereby allowing the user to easily ascertain to what extent communication can be performed depending on where the information processing device is disposed.

For example, when a user purchases a new information processing device, the user displays the communication state information (illustrated in FIG. 18) on the display portion 180 of the information processing device (parent device) 610, and thus the user can easily ascertain an appropriate location at which the new information processing device is to be installed.

Meanwhile, in this example, the communication state information (illustrated in FIG. 18) is displayed on the display portion 180 of the information processing device (parent device) 610, but the communication state information (illustrated in FIG. 18) may be displayed on another information processing device. For example, the measurement information stored in the storage unit 540 of the information processing device (parent device) 610 can be transmitted to the information processing device (child device) 620, and the communication state information (illustrated in FIG. 18) can be displayed on a display portion 621 of the information processing device (child device) 620.

In addition, similar to the second embodiment of the present disclosure, recommended ranges (for example, marks (ellipses or circles) 631 to 633 illustrated in FIG. 18) around the information processing device (parent device) 610 may be displayed on an image by applying AR.

In addition, in this example, a parent device (information processing device (parent device) 610) is installed at a predetermined position, and throughput around the parent device is acquired using one child device (information processing device (child device) 620). However, the throughput around the parent device may be acquired using a plurality of child devices. In addition, a value on which an arithmetic operation (for example, averaging of values acquired by a plurality of child devices located at the same position) is performed may be used as the throughput acquired using the plurality of child devices.

Operation Example of Information Processing Device

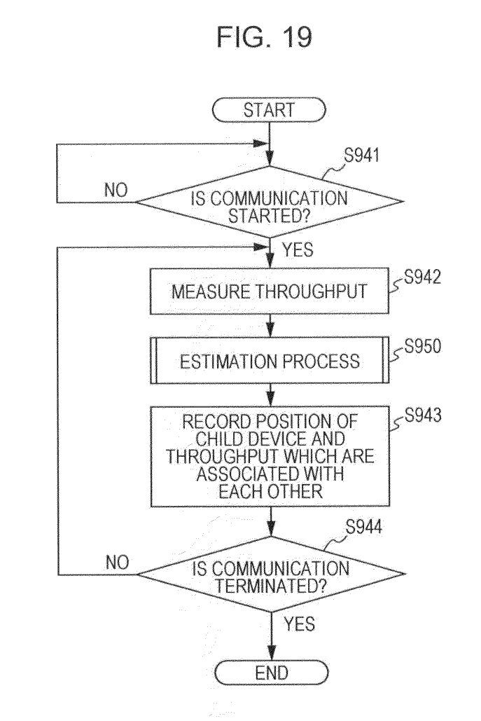

FIG. 19 is a flow chart illustrating an example of a process procedure of a measurement information recording process using the information processing device (parent device) 610 according to the third embodiment of the present disclosure.

First, the control unit 550 of the information processing device (parent device) 610 determines whether wireless communication with the information processing device (child device) 620 is started (step S941). When the communication with the information processing device (child device) 620 is not started, the control unit continuously performs monitoring. On the other hand, when the wireless communication with the information processing device (child device) 620 is started (step S941), and the control unit 550 of the information processing device (parent device) 610 measures throughput regarding the wireless communication with the information processing device (child device) 620 (step S942).

Subsequently, an estimation process for estimating the position of the information processing device (child device) 620 is performed (step S950). The estimation process is the same as the estimation process illustrated in FIG. 12, and thus the description thereof will not be repeated here.

Subsequently, the control unit 550 of the information processing device (parent device) 610 records, in the storage unit 540, the throughput obtained by the measurement and the relative position of the information processing device (child device) 620, estimated by the estimation unit 160, which are associated with each other (step S943).

Subsequently, the control unit 550 of the information processing device (parent device) 610 determines whether wireless communication with the information processing device (child device) 620 is terminated (step S944). When the wireless communication with the information processing device (child device) 620 is not terminated, the process returns to step S942. On the other hand, when the wireless communication with the information processing device (child device) 620 is terminated (step S944), the control unit 550 terminates the operation of the measurement information recording process. Meanwhile, when the measurement of the throughput is performed at the same location a plurality of times, it is possible to obtain a value of the throughput at the location using these measurement results. For example, an average value of the throughput performed a plurality of times can be set to the value of the throughput at the location.

In this manner, for example, the measurement information stored in the storage unit 540 can be displayed on the display portion 180 on the basis of a user's operation. The display allows a user to easily ascertain an appropriate location at which an information processing device is to be installed.

### 4. Fourth Embodiment

In the first to third embodiments of the present disclosure, an example has been described in which the position (direction of another information processing device and distance to another information processing device) of another information processing device is estimated. Here, it is also possible to provide the information estimated using the information processing device described in the first to third embodiments of the present disclosure to another information processing device, and to use the information in another information processing device.

Incidentally, in a fourth embodiment of the present disclosure, a description is given of an example in which information of a child device which is estimated using a parent device is provided to the child device and is used in the child device.

Configuration Example of Communication System and Position Estimation Example of Another Information Processing Device

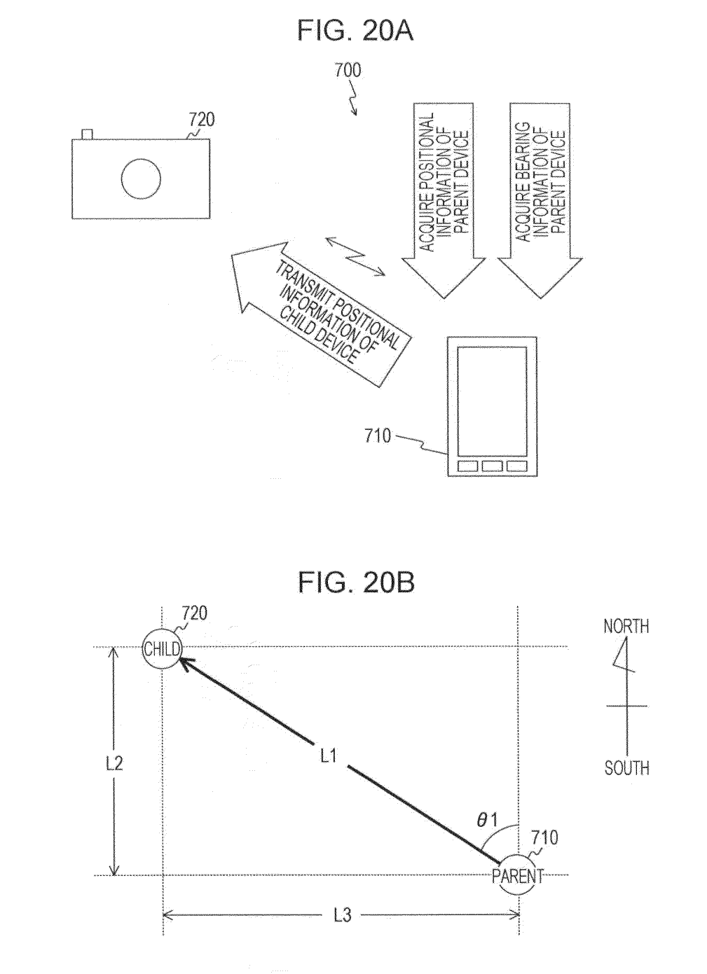

FIGS. 20A and 20B are diagrams illustrating a configuration example of a communication system 700 and a position estimation example of another information processing device according to the fourth embodiment of the present disclosure. FIG. 20A illustrates a configuration example of the communication system 700.

The communication system 700 includes an information processing device (parent device) 710 and an information processing device (child device) 720. The information processing device (parent device) 710 and the information processing device (child device) 720 are information processing devices capable of performing wireless communication using a 60-GHz band. In addition, the information processing device (parent device) 710 is an information processing device serving as a parent device, and the information processing device (child device) 720 is an information processing device serving as a child device.

In addition, the information processing device (parent device) 710 has the same configuration as the information processing device 500 illustrated in FIG. 14. For this reason, in the fourth embodiment of the present disclosure, portions in common with those of the information processing device 500 will be described using the same reference numerals as those of the information processing device 500.

The information processing device (child device) 720 is an information processing device capable of imaging a subject to generate image data and recording the generated image data as an image content (still image content or moving image content) in a recording medium. In addition, the information processing device (child device) 720 can record various pieces of information (attached information) regarding the image content in association with the image content. The information processing device (child device) 720 can record attached information in a still image file that is recorded in accordance with, for example, a design rule for camera file system (DCF) standard. The attached information is, for example, GPS information, orientation information, an imaging update date, an image size, color space information, a manufacturer name.

Meanwhile, the information processing device (child device) 720 is, for example, an imaging device (for example, digital still camera, digital video camera (for example, camera-integrated recorder)). However, the information processing device (child device) 720 does not include a positional information acquisition unit (equivalent to positional information acquisition unit 520 illustrated in FIG. 14).

Here, as described above, the information processing device (child device) 720 can record attached information (for example, positional information) and an image content which are associated with each other. That is, the information processing device (child device) 720 can record positional information (for example, imaging position) at the time of an imaging operation (generation operation) of the image content and the image content which are associated with each other. However, the information processing device (child device) 720 does not include a positional information acquisition unit (equivalent to positional information acquisition unit 520 illustrated in FIG. 14). Incidentally, in the fourth embodiment of the present disclosure, an example is described in which the information processing device (parent device) 710 estimates the position of the information processing device (child device) 720 and the information processing device (child device) 720 uses the estimated position. Meanwhile, the position estimation example is illustrated in FIG. 20B.

FIG. 20B illustrates a position estimation example of the information processing device (child device) 720. FIG. 20B schematically illustrates a geographical relationship (relationship on horizontal plane) between the information processing device (parent device) 710 and the information processing device (child device) 720 which are illustrated in FIG. 20A. In FIG. 20B, an upper direction is set to the north. Meanwhile, the parent 710 illustrated in FIG. 20B means the information processing device (parent device) 710 illustrated in FIG. 20A, and the child 720 illustrated in FIG. 20B means the information processing device (child device) 720 illustrated in FIG. 20A.

The positional information acquisition unit 520 of the information processing device (parent device) 710 acquires positional information (absolute positional information) of the information processing device (parent device) 710. In addition, the orientation information acquisition unit 530 of the information processing device (parent device) 710 acquires orientation information of the information processing device (parent device) 710.

Subsequently, the information processing device (parent device) 710 estimates a relative position of the information processing device (child device) 720 in a case based on the information processing device (parent device) 710 using wireless communication. For example, as illustrated in FIG. 20B, an angle θ1 is calculated as a direction of the information processing device (child device) 720, and a distance L1 is calculated as a distance to the information processing device (child device) 720. In this case, it is possible to obtain a distance of the information processing device (child device) 720 in a north-south direction and a distance in an east-west direction in a case based on the information processing device (parent device) 710, in accordance with a formula of a trigonometric function. That is, the control unit 550 of the information processing device (parent device) 710 calculates a distance L2 as the distance of the information processing device (child device) 720 in the north-south direction and a distance L3 as the distance in the east-west direction in the case based on the information processing device (parent device) 710.

Subsequently, the control unit 550 of the information processing device (parent device) 710 calculates an absolute position (child device coordinate) of the information processing device (child device) 720 using the distance L2 in the north-south direction and the distance L3 in the east-west direction which are calculated in this manner. Specifically, the control unit 550 calculates the latitude of the information processing device (child device) 720 using positional information (latitude) of the information processing device (parent device) 710 and the distance L2 in the north-south direction. In addition, the control unit 550 calculates the longitude of the information processing device (child device) 720 using the positional information (longitude) of the information processing device (parent device) 710 and the distance L3 in the east-west direction.

In this manner, the control unit 550 of the information processing device (parent device) 710 calculates positional information of the information processing device (child device) 720 on the basis of the positional information acquired by the positional information acquisition unit 520 and the position of the information processing device (child device) 720 which is estimated by the estimation unit 160.

Subsequently, the control unit 550 of the information processing device (parent device) 710 transmits the calculated pieces of positional information (latitude and longitude) of the information processing device (child device) 720 to the information processing device (child device) 720 using wireless communication. The information processing device (child device) 720 performs a process of recording an image content using the pieces of positional information (latitude and longitude) of the information processing device (child device) 720 which are transmitted from the information processing device (parent device) 710. That is, the information processing device (child device) 720 records pieces of positional information (latitude and longitude) of the information processing device (child device) 720, which are transmitted from the information processing device (parent device) 710 at the time of an imaging operation (generation operation) of an image content, and the image content which are associated with each other.

Operation Example of Information Processing Device

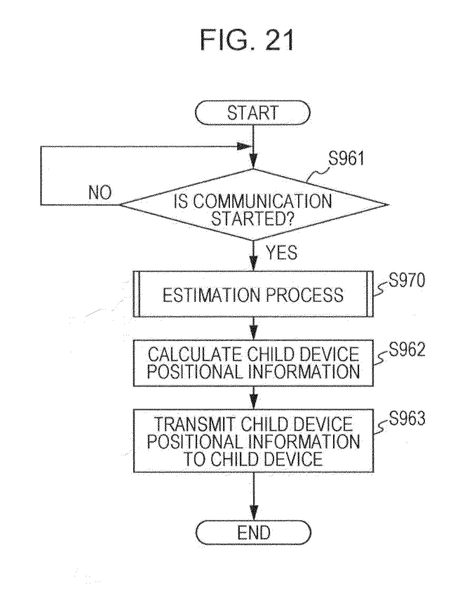

FIG. 21 is a flow chart illustrating an example of a process procedure of a positional information transmission process using the information processing device (parent device) 710 according to the fourth embodiment of the present disclosure. Meanwhile, pieces of positional information acquired by the positional information acquisition unit 520 at fixed intervals or at random intervals are stored in the storage unit 540.

First, the control unit 550 of the information processing device (parent device) 710 determines whether wireless communication with the information processing device (child device) 720 is started (step S961). When the communication with the information processing device (child device) 720 is not started, the control unit continuously performs monitoring. On the other hand, when the wireless communication with the information processing device (child device) 720 is started (step S961), an estimation process for estimating the position of the information processing device (child device) 720 is performed (step S970). The estimation process is the same as the estimation process illustrated in FIG. 12, and thus the description thereof will not be repeated.

Subsequently, the control unit 550 of the information processing device (parent device) 710 calculates positional information (child device coordinate) of the information processing device (child device) 720 on the basis of the positional information of the information processing device (parent device) 710 and the position of the information processing device (child device) 720 which is obtained by the estimation process (step S962).

Subsequently, the control unit 550 of the information processing device (parent device) 710 transmits the calculated positional information (child device coordinate) of the information processing device (child device) 720 to the information processing device (child device) 720 using wireless communication (step S963).

Here, when positional information is acquired using a GPS receiver, time necessary for positioning varies depending on information (for example, orbital information (ephemeris data) or time information), used for positioning, which is held in the GPS receiver. For example, a GPS receiver included in an information processing device having a communication function such as 3rd generation (3G) or long term evolution (LTE) is assumed. The GPS receiver can acquire the information used for positioning from another information processing device (for example, server operated by telecommunications carrier) by the communication function. For this reason, the GPS receiver can perform an acquisition operation of positional information in a relatively short period of time using the acquired information.

On the other hand, since a GPS receiver not capable of acquiring information used for positioning from another information processing device has to acquire information used for positioning from a GPS satellite, an acquisition operation of the positional information may be extended. For example, in a GPS receiver simplex, it may take a few minutes (up to approximately 12 minutes) for position measurement. Here, for example, an imaging device is often powered off in states other than an imaging operation. For this reason, when a GPS receiver asking for a longer period of time for position measurement is included in an image device, it is also assumed that it becomes difficult to record appropriate positional information at the time of an imaging operation.

On the other hand, in the fourth embodiment of the present disclosure, for example, even if an imaging device does not have a GPS function, it is possible to acquire positional information from another information processing device (information processing device asking for a short period of time for position measurement) using wireless communication and to use the positional information. That is, even if an imaging device does not have a GPS function, the imaging device may perform the same function as an imaging device including a GPS function. In addition, even if it is difficult for an imaging device to acquire information used for positioning from another information processing device, the imaging device can perform the same function as an imaging device capable of acquiring information used for positioning from another information processing device.

In addition, it is possible to significantly reduce the time necessary for position measurement using positional information obtained from an information processing device asking for a short period of time for position measurement. In addition, since there is no necessity to include a GPS receiver, it is possible to reduce the cost and size of the information processing device (child device) 720.

Meanwhile, in the first to third embodiments of the present disclosure, an example has been described in which information regarding the position of another information processing device is displayed on a display portion to output the information. However, for example, the information regarding the position of another information processing device may be output from an audio output unit (for example, speaker). For example, it is possible to output a message that “the coffee shop XY is located 20 meters ahead in a direction inclined at an angle of 45 degrees from a traveling direction” from the audio output unit. In addition, the information regarding the position of another information processing device may be output in an electronic device (for example, external audio output device or external display device) which is connected to an information processing device. In this case, the information regarding the position of another information processing device is transmitted to the electronic device from the information processing device, and the information is output from the electronic device.

In addition, it is possible to apply the embodiments of the present disclosure to an information processing device (for example, electronic device (home electrical appliance or game machine) which has wireless communication function, or fixed-type information processing device (for example, wireless communication device for collecting data of vending machine)) other than the above-described information processing devices.

Meanwhile, the above-described embodiments have described an example for realizing the present disclosure, and matters in the embodiments correspond to disclosure specific matters in claims, respectively. Similarly, the disclosure specific matters in claims respectively correspond to matters in the embodiments of the present disclosure to which the same names as the disclosure specific matters in claims are given. However, the present disclosure is not limited to the embodiments, and various modifications can be made without departing from the scope of the appended claims or the equivalents thereof.

In addition, the process procedure described in the above-described embodiments may be considered as a method having these series of procedures, and may be considered as a program for causing a computer to execute these series of procedures or a recording medium that stores the program. Examples of the recording medium may include a compact disc (CD), a minidisc (MD), a digital versatile disk (DVD), a memory card, a Blu-ray disc (registered trademark), and the like.

Meanwhile, the present disclosure can adopt the following configuration.

(1) An information processing device including: a communication unit that performs wireless communication using a specific band with another information processing device; and an estimation unit that estimates a position of the another information processing device on the basis of information regarding a beam used at the time of the wireless communication.

(2) The information processing device according to the above (1), in which the information regarding the beam includes angle information for specifying at least one of a transmission direction of a transmitted beam used at the time of the wireless communication and a reception direction of a received beam used at the time of the wireless communication, and in which the estimation unit calculates a direction of the another information processing device in a case based on a position of the information processing device on the basis of the angle information to estimate the position of the another information processing device.

(3) The information processing device according to the above (2), in which the estimation unit calculates reliability regarding the calculated direction of the another information processing device on the basis of the angle information.

(4) The information processing device according to any one of the above (1) to (3), in which the information regarding the beam includes received signal intensity at the time of the wireless communication, and in which the estimation unit calculates a distance between the information processing device and the another information processing device on the basis of the received signal intensity to estimate the position of the another information processing device.

(5) The information processing device according to any one of the above (1) to (4), further including a control unit that displays display information for specifying the estimated position of the another information processing device on a display portion.

(6) The information processing device according to the above (5), in which the control unit displays information regarding a location at which the another information processing device is installed and the display information which are associated with each other.

(7) The information processing device according to the above (5) or (6), in which the control unit displays the display information so as to overlap an image generated by an imaging unit.

(8) The information processing device according to any one of the above (5) to (7), in which the control unit displays at least one of a mark indicating a direction of the another information processing device in a case based on a position of the information processing device and a mark indicating a distance between the information processing device and the another information processing device, as the display information, on the display portion.

(9) The information processing device according to any one of the above (5) to (8), in which the estimation unit calculates reliability regarding the calculated direction of the another information processing device on the basis of the angle information, and in which the control unit changes a display mode of the display information on the basis of the calculated reliability.

(10) The information processing device according to any one of the above (1) to (9), further including a control unit that records communication state information in which the estimated position of the another information processing device and information regarding a state of wireless communication performed with the another information processing device are associated with each other.

(11) The information processing device according to any one of the above (1) to (10), further including a control unit that displays the estimated position of the another information processing device and information regarding a state of wireless communication performed with the another information processing device which are associated with each other.

(12) The information processing device according to any one of the above (1) to (11), further including a control unit that transmits information regarding the estimated position of the another information processing device to the another information processing device.

(13) The information processing device according to the above (12), further including a positional information acquisition unit that acquires positional information regarding a position of the information processing device, in which the control unit calculates positional information regarding a position of the another information processing device on the basis of the acquired positional information and the estimated position of the another information processing device, and transmits the calculated positional information to the another information processing device.

(14) The information processing device according to any one of the above (1) to (13), in which the specific band is a high-frequency band, and in which the communication unit performs wireless communication using the high-frequency band with the another information processing device.

(15) An information processing method including: a communication procedure of performing wireless communication using a specific band with another information processing device; and an estimation procedure of estimating a position of the another information processing device on the basis of information regarding a beam used at the time of the wireless communication.

(16) A program causing a computer to execute: a communication procedure of performing wireless communication using a specific band with another information processing device; and an estimation procedure of estimating a position of the another information processing device on the basis of information regarding a beam used at the time of the wireless communication.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a communication unit that performs wireless communication using a specific band with another information processing device; and
an estimation unit that estimates a position of the another information processing device on the basis of information regarding a beam used at the time of the wireless communication.

2. The information processing device according to claim 1,
wherein the information regarding the beam includes angle information for specifying at least one of a transmission direction of a transmitted beam used at the time of the wireless communication and a reception direction of a received beam used at the time of the wireless communication, and
wherein the estimation unit calculates a direction of the another information processing device in a case based on a position of the information processing device on the basis of the angle information to estimate the position of the another information processing device.

3. The information processing device according to claim 2, wherein the estimation unit calculates reliability regarding the calculated direction of the another information processing device on the basis of the angle information.

4. The information processing device according to claim 1,
wherein the information regarding the beam includes received signal intensity at the time of the wireless communication, and
wherein the estimation unit calculates a distance between the information processing device and the another information processing device on the basis of the received signal intensity to estimate the position of the another information processing device.

5. The information processing device according to claim 1, further comprising a control unit that displays display information for specifying the estimated position of the another information processing device on a display portion.

6. The information processing device according to claim 5, wherein the control unit displays information regarding a location at which the another information processing device is installed and the display information which are associated with each other.

7. The information processing device according to claim 5, wherein the control unit displays the display information so as to overlap an image generated by an imaging unit.

8. The information processing device according to claim 5, wherein the control unit displays at least one of a mark indicating a direction of the another information processing device in a case based on a position of the information processing device and a mark indicating a distance between the information processing device and the another information processing device, as the display information, on the display portion.

9. The information processing device according to claim 5,
wherein the estimation unit calculates reliability regarding the calculated direction of the another information processing device on the basis of the angle information, and
wherein the control unit changes a display mode of the display information on the basis of the calculated reliability.

10. The information processing device according to claim 1, further comprising a control unit that records communication state information in which the estimated position of the another information processing device and information regarding a state of wireless communication performed with the another information processing device are associated with each other.

11. The information processing device according to claim 1, further comprising a control unit that displays the estimated position of the another information processing device and information regarding a state of wireless communication performed with the another information processing device which are associated with each other.

12. The information processing device according to claim 1, further comprising a control unit that transmits information regarding the estimated position of the another information processing device to the another information processing device.

13. The information processing device according to claim 12, further comprising a positional information acquisition unit that acquires positional information regarding a position of the information processing device,
wherein the control unit calculates positional information regarding a position of the another information processing device on the basis of the acquired positional information and the estimated position of the another information processing device, and transmits the calculated positional information to the another information processing device.

14. The information processing device according to claim 1,
wherein the specific band is a high-frequency band, and
wherein the communication unit performs wireless communication using the high-frequency band with the another information processing device.

15. An information processing method comprising:
a communication procedure of performing wireless communication using a specific band with another information processing device; and
an estimation procedure of estimating a position of the another information processing device on the basis of information regarding a beam used at the time of the wireless communication.

16. A program causing a computer to execute:
a communication procedure of performing wireless communication using a specific band with another information processing device; and
an estimation procedure of estimating a position of the another information processing device on the basis of information regarding a beam used at the time of the wireless communication.
